(19) United States
(12) Patent Application Publication
(10) Pub. No.: US 2021/0258456 A1
(43) Pub. Date: Aug. 19, 2021

(54) INTERCHANGEABLE LENS, IMAGING APPARATUS, AND ROTATION DETECTION APPARATUS

(71) Applicant: SONY CORPORATION, TOKYO (JP)

(72) Inventors: REI SAKAMOTO, (US); TOMOHIRO YASUI, (US)

(21) Appl. No.: 17/250,207

(22) PCT Filed: Apr. 5, 2019
(86) PCT No.: PCT/JP2019/015120

§ 371 Date: Dec. 15, 2020

(30) Foreign Application Priority Data
Jun. 22, 2018 (JP) 2018-119274

(51) Int. Cl. H04N 5/225; G02B 7/04; G02B 23/24; G03B 17/14

(52) U.S. Cl. CPC H04N 5/2254; G02B 7/04; H04N 2005/2255; G03B 17/14; G02B 23/243

(57) ABSTRACT

A favorable transmission state of rotation power from an operation ring to a rotating element is ensured, and an improvement in responsiveness associated with rotation detection is achieved. An interchangeable lens includes: an operation ring that has a tooth section extending in a rotation direction and that is operated to be rotatable; a rotating element that has a gear section provided in an outer circumferential portion and engaged with the tooth section, a rotation amount of the rotating element being detected by a rotation detection sensor; and a transmission ring that is rotated in proportion to rotation of the operation ring, and that transmits rotation power of the operation ring to the rotating element, in which the transmission ring is pressed against either the operation ring or the rotating element, and the rotating element is rotated by the rotation power transmitted from the operation ring via the transmission ring.

### TECHNICAL FIELD

The present technology relates to a technical field associated with an interchangeable lens, an imaging apparatus, and a rotation detection apparatus each having an operation ring that can be operated to be rotated.

### BACKGROUND ART

Optical elements such as a lens are disposed in a structure used in photographing of an imaging apparatus of every kind such as a video camera and a still camera, an interchangeable lens, or the like.

In such a structure, the lens is moved in an optical axis direction to provide, for example, zoom or focusing. In addition, a structure in which blade members such as an iris that is an optical element are actuated to regulate a capture amount of light by an image pickup element.

For example, a motion such as zoom or focusing is provided by rotating an operation ring such as a zoom ring or a focus ring and moving the lens in the optical axis direction in response to a rotation amount and a rotation direction of the operation ring.

For example, in the zoom, the lens is moved from a telephoto side to a wide angle side by rotating the operation ring in one rotation direction, and moved from the wide angle side to the telephoto side by rotating the operation ring in the other rotation direction.

In such a structure, rotation power of the operation ring is transmitted to a rotating element located inside of the operation ring, a rotation detection sensor detects a rotation amount and a rotation direction of the rotating element, and the lens is moved in response to the rotation amount and the rotation direction detected by the rotation detection sensor to perform the motion such as zoom or focusing (refer to, for example, PTL 1 and PTL 2).

In a structure described in PTL 1, an elastic rotation member (rotating element) is located inside of an operation ring, part of the elastic rotation member is pressed against part of the operation ring, and rotation power of the operation ring is transmitted to the elastic rotation member by a friction force between the operation ring and the elastic rotation member.

In a structure described in PTL 2, an internal gear is provided on an inner surface side of an operation ring, a cylindrical electrode section (rotating element) having an external gear is located inside of the operation ring, the internal gear is engaged with the external gear, and rotation power of the operation ring is transmitted to the cylindrical electrode section via the internal gear and the external gear.

### CITATION LIST

### Patent Literature

### [PTL 1]

JP 2016-118576A

### [PTL 2]

JP 2016-38421A

### SUMMARY

### Technical Problem

Meanwhile, the imaging apparatus, the interchangeable lens, or the like is used not only indoor but also outdoor in many cases, an environment in which the imaging apparatus, the interchangeable lens, or the like is used varies, and the imaging apparatus, the interchangeable lens, or the like is used even in environments such as a high-temperature environment and a high-humidity environment. As a result, an influence in response to any of these environments is possibly exerted on motions of the sections in the imaging apparatus, the interchangeable lens, or the like.

For example, with a configuration that the rotation power of the operation ring is transmitted to the rotating element by the friction force between the operation ring and the rotating element as in the imaging apparatus described in PTL 1, the following problem possibly occurs. If moisture adheres to a contact part between the operation ring and the rotating element or physical properties of the operation ring and the rotating element change due to an influence of a utilization environment, for example, then a friction coefficient changes, the rotating element slides relatively to the operation ring at the time of rotating the operation ring, and the transmission of the rotation power from the operation ring to the rotating element is adversely influenced.

On the other hand, with a structure of transmitting the rotation power of the operation ring to the rotating element via a gear mechanism as in PTL 2, the rotating element does not slide at the time of rotating the operation ring; however, responsiveness associated with rotation detection is possibly, insufficiently poor because of the presence of a backlash in the gear mechanism.

Therefore, an object of an interchangeable lens, an imaging apparatus, and a rotation detection apparatus according to the present technology is to overcome the problems described above, to ensure a favorable transmission state of rotation power from an operation ring to a rotating element, and to achieve an improvement in responsiveness associated with rotation detection.

### Solution to Problem

First, an interchangeable lens according to the present technology includes: an operation ring that has a tooth section extending in a rotation direction and that is operated to be rotatable; a rotating element that has a gear section provided in an outer circumferential portion and engaged with the tooth section, a rotation amount of the rotating element being detected by a rotation detection sensor; and a transmission ring that is rotated in proportion to rotation of the operation ring, and that transmits rotation power of the operation ring to the rotating element, the transmission ring being pressed against either the operation ring or the rotating element, and the rotating element being rotated by the rotation power transmitted from the operation ring via the transmission ring.

The transmission ring is thereby pressed against the operation ring or the rotating element in a state in which the tooth section of the operation ring is engaged with the gear section of the rotating element, and the rotating element is rotated by the rotation power of the operation ring transmitted via the transmission ring.

Second, the interchangeable lens according to the present technology is desirably configured such that a transmission section is provided in the operation ring, the transmission ring is mounted to the rotating element and an outer circumferential portion of the transmission ring is pressed against the transmission section, and the rotating element is rotated coaxially and integrally with the transmission ring by the rotation power of the operation ring transmitted from the transmission section via the transmission ring.

The rotation power is thereby applied to the rotating element from the operation ring via the transmission ring in a state in which the transmission ring mounted to the rotating element is pressed against the operation ring.

Third, the interchangeable lens according to the present technology is desirably configured such that at least part of a contact surface of the transmission ring on which the transmission ring contacts the transmission section is located between an addendum circle and a dedendum circle of the tooth section at an engagement position between the tooth section and the gear section in a radial direction of the rotating element.

The transmission ring and the rotating element are thereby brought into a state of contact with the transmission section and the tooth section, respectively at the generally same position in the radial direction; thus, it is difficult to apply a force that generates a speed difference between the transmission ring and the rotating element to the transmission ring and the rotating element when the rotation power is transmitted to the rotating element from the operation ring.

Fourth, the interchangeable lens according to the present technology is desirably configured such that a circumferential center of the contact surface is located between the addendum circle and the dedendum circle of the tooth section at the engagement position between the tooth section and the gear section in the radial direction of the rotating element.

The transmission ring and the rotating element are thereby brought into the state of contact with the transmission section and the tooth section, respectively at the generally same position in the radial direction; thus, it is difficult to apply the force that generates the speed difference between the transmission ring and the rotating element to the transmission ring and the rotating element when the rotation power is transmitted to the rotating element from the operation ring.

Fifth, the interchangeable lens according to the present technology is desirably configured such that at least part of a contact surface of the transmission ring on which the transmission ring contacts the transmission section coincides with a reference pitch circle of the tooth section at an engagement position between the tooth section and the gear section in a radial direction of the rotating element.

The transmission ring and the rotating element are thereby brought into the state of contact with the transmission section and the tooth section, respectively at the generally same position in the radial direction; thus, it is difficult to apply the force that generates the speed difference between the transmission ring and the rotating element to the transmission ring and the rotating element when the rotation power is transmitted to the rotating element from the operation ring.

Sixth, the interchangeable lens according to the present technology is desirably configured such that a contact position of the transmission ring at which the transmission ring contacts the transmission section is located between an addendum circle and a dedendum circle of the tooth section at an engagement position between the tooth section and the gear section in a radial direction of the rotating element.

The transmission ring and the rotating element are thereby brought into the state of contact with the transmission section and the tooth section, respectively at the generally same position in the radial direction; thus, it is difficult to apply the force that generates the speed difference between the transmission ring and the rotating element to the transmission ring and the rotating element when the rotation power is transmitted to the rotating element from the operation ring.

Seventh, the interchangeable lens according to the present technology is desirably configured such that the contact position of the transmission ring at which the transmission ring contacts the transmission section coincides with a reference pitch circle of the tooth section at the engagement position between the tooth section and the gear section in the radial direction of the rotating element.

The transmission ring and the rotating element are thereby brought into the state of contact with the transmission section and the tooth section, respectively at the generally same position in the radial direction; thus, the force that generates the speed difference between the transmission ring and the rotating element is not applied to the transmission ring and the rotating element when the rotation power is transmitted to the rotating element from the operation ring.

Eighth, the interchangeable lens according to the present technology is desirably configured such that a biasing member that biases the transmission ring in a direction in which the outer circumferential portion of the transmission ring is pressed against the transmission section is provided.

The outer circumferential portion of the transmission ring is thereby biased by the biasing member and pressed against the transmission section; thus, it is difficult to generate slide of the transmission ring relative to the operation ring at the time of rotating the operation ring.

Ninth, the interchangeable lens according to the present technology is desirably configured such that the rotating element and the transmission ring are rotated with a rotary shaft used as a supporting point, and that a biasing direction in which the biasing member biases the transmission ring is made to coincide with an axial direction of the rotary shaft.

The transmission ring is thereby biased to the axial direction of the rotary shaft by the biasing member and pressed against the transmission section; thus, the biasing force of the biasing member is not applied to the rotation direction of the rotating element and the transmission ring.

Tenth, the interchangeable lens according to the present technology is desirably configured such that a press receiving surface against which the transmission ring is pressed is formed on the transmission section, and that an outer circumferential surface of the transmission ring is formed into a curved shape projected outward.

The outer circumferential surface formed into the curved shape projected outward is thereby pressed against the press receiving surface; thus, it is easier to press the transmission ring against the transmission section in a state of the point contact.

Eleventh, the interchangeable lens according to the present technology is desirably configured such that a cross-sectional shape of the transmission ring in a direction orthogonal to a circumferential direction is formed into a circular shape.

The transmission ring is thereby made simple in shape.

Twelfth, the interchangeable lens according to the present technology is desirably configured such that a disposition recessed portion extending in a circumferential direction is formed in the rotating element, and that the transmission ring is disposed in the disposition recessed portion.

The transmission ring is thereby pressed against the transmission section in a state of being disposed in the disposition recessed portion; thus, a combination of the rotating element and the transmission ring is not made large in size as a whole.

Thirteenth, the interchangeable lens according to the present technology is desirably configured such that the tooth section is provided on an inner circumferential side of the operation ring.

The rotating element is thereby brought into a state of being covered with the operation ring from outside.

Fourteenth, the interchangeable lens according to the present technology is desirably configured such that the transmission ring is formed from a rubber material.

The transmission ring formed from the rubber material is thereby pressed against the transmission section; thus, the friction force between the transmission section and the transmission ring is high.

Fifteenth, the interchangeable lens according to the present technology is desirably configured such that a transmission receiving section is provided on the rotating element, that the transmission ring is mounted to the operation ring and the outer circumferential portion of the transmission ring is pressed against the transmission receiving section, and that the rotating element is rotated by the rotation power of the operation ring transmitted via the transmission receiving section.

The rotation power is thereby applied to the rotating element from the operation ring via the transmission ring in a state in which the transmission ring mounted to the operation ring is pressed against the rotating element.

Sixteenth, the interchangeable lens according to the present technology is desirably configured such that a contact position of the transmission ring at which the transmission ring contacts the transmission receiving section is located between an addendum circle and a dedendum circle of the tooth section at an engagement position between the tooth section and the gear section in a radial direction of the rotating element.

The rotating element is thereby brought into the state of contact with the transmission ring and the tooth section at the generally same position in the radial direction; thus, it is difficult to apply the force that generates the speed difference between the transmission ring and the rotating element to the transmission ring and the rotating element when the rotation power is transmitted to the rotating element from the operation ring.

Seventeenth, the interchangeable lens according to the present technology is desirably configured such that the contact position of the transmission ring at which the transmission ring contacts the transmission receiving section is made to coincide with a reference pitch circle of the tooth section at the engagement position between the tooth section and the gear section in the radial direction of the rotating element.

The rotating element is thereby brought into the state of contact with the transmission ring and the tooth section at the generally same position in the radial direction, and the force that generates the speed difference between the transmission ring and the rotating element is not applied to the transmission ring and the rotating element when the rotation power is transmitted to the rotating element from the operation ring.

Eighteenth, an imaging apparatus according to the present technology includes an interchangeable lens that has a lens disposed therein; and an image pickup element that converts an optical image incorporated via the interchangeable lens into an electrical signal, the interchangeable lens including: an operation ring that has a tooth section extending in a rotation direction and that is operated to be rotatable; a rotating element that has a gear section provided in an outer circumferential portion and engaged with the tooth section; a rotation detection sensor that detects a rotation amount of the rotating element; and a transmission ring that is rotated in proportion to rotation of the operation ring, and that transmits rotation power of the operation ring to the rotating element, the transmission ring being pressed against either the operation ring or the rotating element, and the rotating element being rotated by the rotation power transmitted from the operation ring via the transmission ring.

The transmission ring is thereby pressed against the operation ring or the rotating element in a state in which the tooth section of the operation ring is engaged with the gear section of the rotating element, and the rotating element is rotated by the rotation power of the operation ring transmitted via the transmission ring.

Nineteenth, a rotation detection apparatus according to the present technology includes: an operation ring that has a tooth section extending in a rotation direction and that is operated to be rotatable; a rotating element that has a gear section provided in an outer circumferential portion and engaged with the tooth section; a rotation detection sensor that detects a rotation amount of the rotating element; and a transmission ring that is rotated in proportion to rotation of the operation ring, and that transmits rotation power of the operation ring to the rotating element, the transmission ring being pressed against either the operation ring or the rotating element, and the rotating element being rotated by the rotation power transmitted from the operation ring via the transmission ring.

The transmission ring is thereby pressed against the operation ring or the rotating element in a state in which the tooth section of the operation ring is engaged with the gear section of the rotating element, and the rotating element is rotated by the rotation power of the operation ring transmitted via the transmission ring.

### Advantageous Effect of Invention

According to the present technology, the transmission ring is pressed against the operation ring or the rotating element in a state in which the tooth section of the operation ring is engaged with the gear section of the rotating element, and the rotating element is rotated by the rotation power of the operation ring transmitted via the transmission ring; thus, it is possible to ensure a favorable transmission state of the rotation power from the operation ring to the rotating element and improve responsiveness associated with rotation detection.

It is noted that the advantages described in the present specification are given as an example only, and that advantages are not limited to those described in the present specification and may contain other advantages.

### BRIEF DESCRIPTION OF DRAWINGS

FIG. 1, as well as FIGS. 2 to 14, depicts an embodiment of an interchangeable lens, an imaging apparatus, and a rotation detection apparatus according to the present technology, and

FIG. 1 is a perspective view of the imaging apparatus depicted with the interchangeable lens and an apparatus main body separated.

FIG. 2 is a cross-sectional view depicting part of the interchangeable lens in a direction of a plane including an optical axis.

FIG. 3 is a cross-sectional view depicting part of the interchangeable lens in a direction of a plane orthogonal to the optical axis.

FIG. 4 is an exploded perspective view depicting part of the interchangeable lens.

FIG. 5 is a perspective view depicting part of the interchangeable lens.

FIG. 6 is a conceptual diagram depicting a position relationship between a contact position at which a transmission ring contacts a transmission section and a gear section.

FIG. 7 is a cross-sectional view depicting a first modification.

FIG. 8 is a cross-sectional view depicting a second modification.

FIG. 9 is a cross-sectional view depicting a third modification.

FIG. 10 is a cross-sectional view depicting a fourth modification.

FIG. 11 is a cross-sectional view depicting the other configuration of the interchangeable lens.

FIG. 12 is a block diagram of the imaging apparatus.

FIG. 13 is a view depicting an example of a schematic configuration of an endoscopic surgery system.

FIG. 14 is a block diagram depicting an example of a functional configuration of a camera head and a camera control unit (CCU) depicted in FIG. 13.

### DESCRIPTION OF EMBODIMENT

An embodiment of the present technology will be described hereinafter with reference to the accompanying drawings.

In the embodiment described hereinafter, an imaging apparatus according to the present technology is applied to a video camera, an interchangeable lens according to the present technology is applied to an interchangeable lens detachably attached to an apparatus main body of this video camera, and a rotation detection apparatus according to the present technology is applied to a rotation detection apparatus provided in this interchangeable lens.

It is noted that an applicable range of the present technology is not limited to the video camera, the interchangeable lens detachably attached to the apparatus main body of the video camera, and the rotation detection apparatus provided in the interchangeable lens detachably attached to the apparatus main body of the video camera. The present technology is widely applicable to, for example, an imaging apparatus of every kind incorporated into a still camera or the other apparatus as the imaging apparatus, an interchangeable lens detachably attached to an apparatus main body of each of these imaging apparatuses, and a rotation detection apparatus provided in each of these imaging apparatuses. The present technology is also applicable to, for example, accessories attached to the interchangeable lens or the imaging apparatus and operating the interchangeable lens and an operation section such as an operation ring of the imaging apparatus.

It is assumed in the following description that front and back, up and down, and right and left directions are directions viewed from a photographer at a time of photographing with the video camera. Therefore, an object side is forward and an image surface side is rearward.

It is noted that the front and back, up and down, and right and left directions indicated hereinafter are assumed for the sake of convenience of description and that the directions are not limited to these directions for carrying out the present technology.

Furthermore, a lens group described hereinafter may not only be configured with one or a plurality of lenses but also include one or a plurality of lenses and other optical elements such as a diaphragm and an iris.

### <Configuration of Imaging Apparatus>

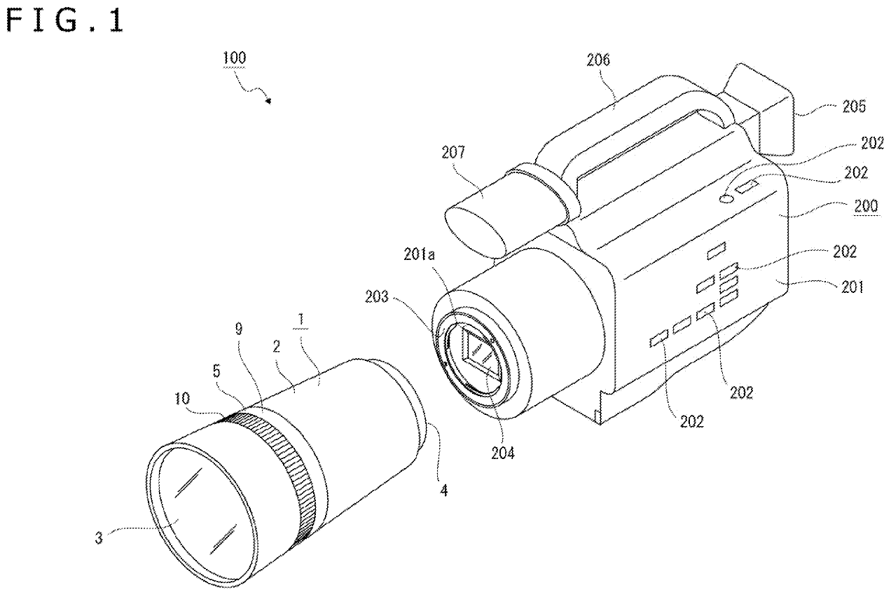

An imaging apparatus 100 is configured with an apparatus main body 200 and an interchangeable lens 1 (refer to FIG. 1).

The apparatus main body 200 is configured such that required sections thereof are disposed inside or outside of an outer casing 201.

For example, various kinds of operation sections 202, 202, . . . , are disposed on surfaces of the outer casing 201 such as an upper surface, a rear surface, and a side surface. Examples of the operation sections 202, 202, . . . , include a power button, a photographing button, a zoom knob, and a mode switching knob.

A circular opening 201a is formed in the front surface of the outer casing 201, and a surrounding portion of the opening 201a is provided as a mount section 203 onto which the interchangeable lens 1 is mounted.

An image pickup element 204 such as a CCD (Charge Coupled Device) or a CMOS (Complementary Metal-Oxide Semiconductor) is disposed within the outer casing 201, and the image pickup element 204 is located in rear of the opening 201a.

A viewfinder 205 is provided in a rear end portion of the apparatus main body 200, and a handle 206 is provided in an upper end portion thereof. A microphone 207 is mounted in a front end portion of the handle 206. Furthermore, a speaker, not depicted, is disposed in the apparatus main body 200.

### <Configuration of Interchangeable Lens>

The interchangeable lens 1 is, for example, an interchangeable lens for a lens interchangeable digital camera.

The interchangeable lens 1 has a casing 2 formed into a generally cylindrical shape and a photographic lens 3 disposed on a forefront side. A lens mount 4 coupled with the mount section 203 of the apparatus main body 200 is provided in a rear end portion of the interchangeable lens 1. An operation ring 5 that functions as, for example, a manual focus ring is provided on the interchangeable lens 1.

It is noted that a zoom ring and an operation ring for opening/closing an iris may be provided on the interchangeable lens 1 in addition to the operation ring 5.

A plurality of optical elements, not depicted, aligned in an optical axis direction (longitudinal direction) is disposed within the casing 2. Examples of the optical elements disposed within the casing 2 include a lens group and iris blades.

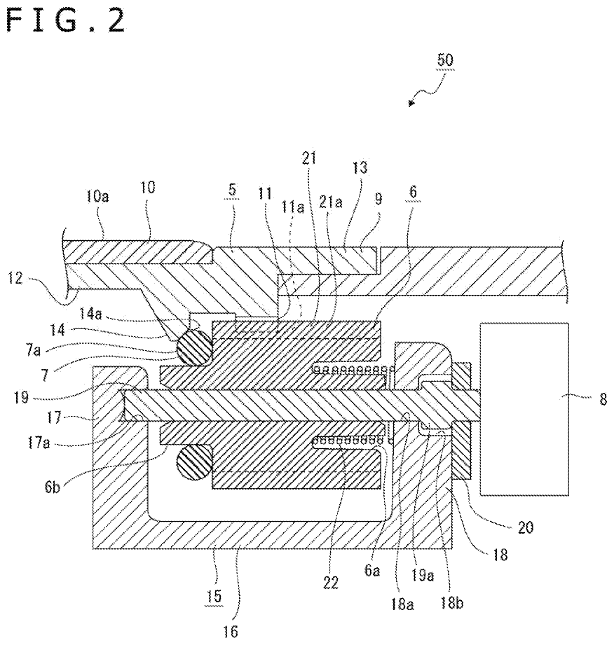

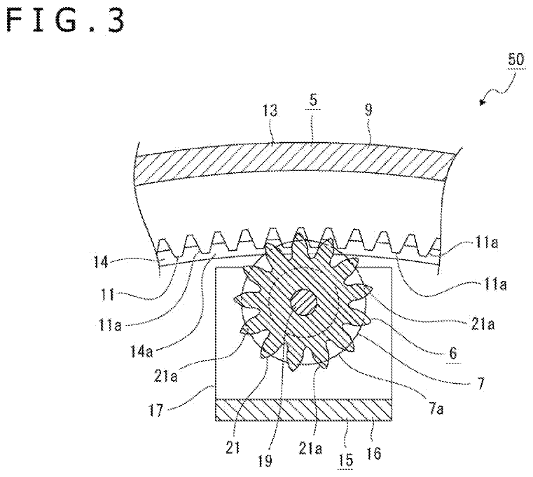

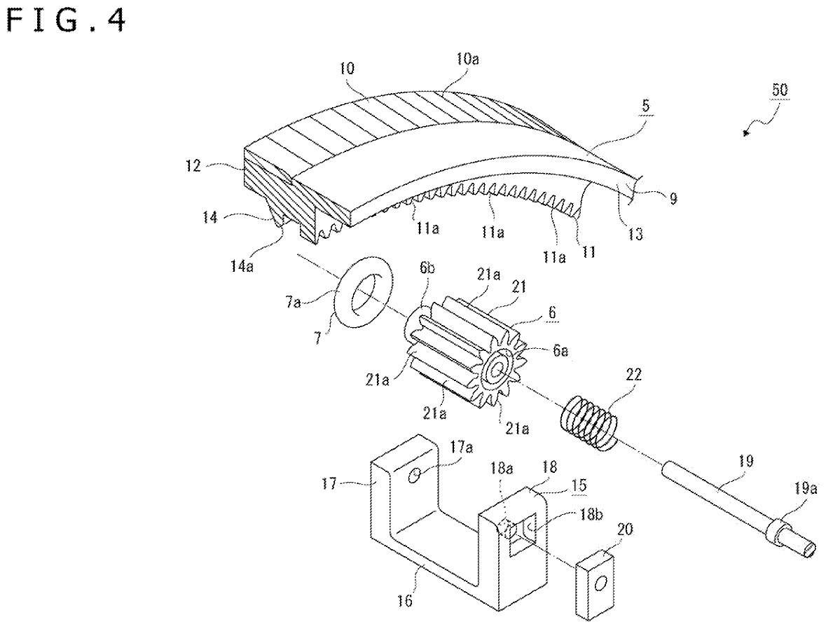

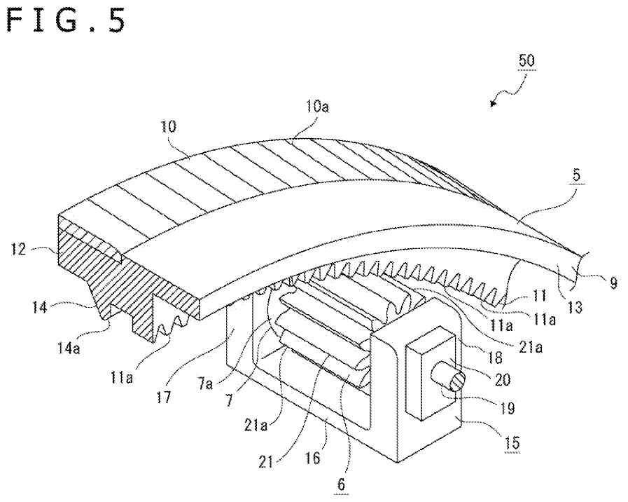

A rotation detection apparatus 50 is provided in the interchangeable lens 1 (refer to FIGS. 2 to 5). The rotation detection apparatus 50 is configured with the operation ring 5 described above, a rotating element 6 rotated by rotation power of the operation ring 5 transmitted to the rotating element 6, a transmission ring 7 rotated integrally with the rotating element 6, and a rotation detection sensor 8 that detects a rotation amount and a rotation direction of the rotating element 6.

The operation ring 5 has a base ring 9, an operating ring 10, and a tooth section 11.

The base ring 9 has a cylindrical front base section 12, a cylindrical rear base section 13 at a diameter set slightly larger than a diameter of the front base section 12, and a transmission section 14 protruding from an inner circumferential surface of the front base section 12. The transmission section 14 protrudes inward from a position closer to a rear end on an inner surface of the front base section 12 and is formed into a ring shape. The transmission section 14 has a press receiving surface 14a formed into a shape at a smaller longitudinal width in a radial direction as the press receiving surface 14a is farther from the front base section 12 and provided in a tip end portion in a protrusion direction in which the transmission section 14 protrudes from the front base section 12. The press receiving surface 14a is formed as part of a rear surface of the transmission section 14 and formed into an inclined surface displacing forward as the press receiving surface 14a is closer to a tip end of the transmission section 14.

The operating ring 10 is a section on which a user puts a user's finger and which is operated by the user, formed into a cylindrical shape, and fixed to an outer circumferential surface of the front base section 12. An outer circumferential surface 10a of the operating ring 10 is knurled, for example, so that favorable operability can be ensured without finger slipping when the user puts the finger on the operating ring 10.

The tooth section 11 has gear racks 11a, 11a, . . . , provided in an inner circumferential portion thereof, each formed into a generally annular shape, extending in a rotation direction of the operation ring 5, and aligned in a circumferential direction. The tooth section 11 is fixed to an inner circumferential surface of the base ring 9, and fixed to a location spreading through the front base section 12 and the rear base section 13 in rear of the transmission section 14.

A holder 15 is disposed in an upper end portion of an internal space of the casing 2. The holder 15 has a base 16 extending longitudinally, a front support section 17 protruding upward from a front end portion of the base 16, and a rear support section 18 protruding upward from a rear end portion of the base 16. A bearing recessed portion 17a is formed in the front support section 17 to open rearward. A shaft support hole 18a is formed in the rear support section 18 to longitudinally penetrate the rear support section 18. A shaft disposed space 18b is formed in the rear support section 18 to communicate with a rear opening of the shaft support hole 18a and to open rearward.

A rotary shaft 19 is supported by the holder 15 to be rotatable in an axial direction. A portion closer to a rear end of the rotary shaft 19 is provided as a large-diameter portion 19a larger in diameter than other portions. A front end portion of the rotary shaft 19 is inserted into the bearing recessed portion 17a of the front support section 17, while a front portion of the large-diameter portion 19a is inserted into the shaft support hole 18a and the large-diameter portion 19a is located in the shaft disposed space 18b. The rotary shaft 19 is supported by the holder 15 by causing the large-diameter portion 19a to be pressed by a shaft pressing element 20 mounted on the rear support section 18 from backward.

The rotating element 6 is fixed to the rotary shaft 19 and rotated with the rotary shaft 19 as a supporting point. The rotating element 6 is formed into a generally cylindrical shape and has a gear section 21 on an outer circumferential portion. The gear section 21 has a plurality of gear teeth 21a, 21a, . . . , aligned in a circumferential direction of the gear section 21. A spring insertion groove 6a is formed in the rotating element 6 to open rearward, and the spring insertion groove 6a is formed into a cylindrical shape. A disposition recessed portion 6b is formed in a front end portion of the rotating element 6 to open forward and radially. The gear section 21 of the rotating element 6 is engaged with the tooth section 11 of the operation ring 5.

A biasing spring 22 which is used as a biasing member is inserted into the spring insertion groove 6a of the rotating element 6, and a compression coil spring, for example, is used as the biasing spring 22. A front end of the biasing spring 22 is pressed against part of the rotating element 6, while a rear end thereof is pressed against a front surface of the rear support section 18 of the holder 15. Therefore, the rotating element 6 is biased in a forward direction that is one axial direction of the rotary shaft 19 by the biasing spring 22.

The transmission ring 7 is fixed to the rotating element 6 in a state of being disposed in the disposition recessed portion 6b. Therefore, the transmission ring 7 is rotated integrally with the rotating element 6. The transmission ring 7 is formed from, for example, a hard rubber material. It is noted, however, that the transmission ring 7 may be formed from a material other than the rubber material as long as the material exhibits high adhesiveness to the transmission section 14, and the transmission ring 7 may be formed from, for example, a resin material. Furthermore, a surface of the transmission ring 7 may be subjected to a surface treatment such as non-slip coating so that a friction force of the transmission ring 7 can be enhanced.

An outer circumferential surface 7a of the transmission ring 7 is formed into a curved shape projected outward and a cross-sectional shape of the transmission ring 7 in a direction orthogonal to a circumferential direction of the transmission ring 7 is formed into, for example, a circular shape. A biasing force of the biasing spring 22 is applied to the transmission ring 7 via the rotating element 6, and the transmission ring 7 is biased forward together with the rotating element 6.

The transmission ring 7 is brought into a state of coming in contact with a press receiving surface 14a of the transmission section 14 in the operation ring 5 from rearward. Since the transmission ring 7 is biased forward by the biasing spring 22 at this time, the outer circumferential surface 7a is pressed against the press receiving surface 14a. Therefore, when the operation ring 5 is operated to be rotated, then the rotation power of the operation ring 5 is transmitted from the transmission section 14 to the transmission ring 7 and the rotating element 6 by the friction force, and the transmission ring 7 and the rotating element 6 are rotated integrally in the same direction as a rotation direction of the operation ring 5 in proportion to rotation of the operation ring 5.

Since the cross-sectional shape of the transmission ring 7 in the direction orthogonal to the circumferential direction is formed into the circular shape and the press receiving surface 14a of the transmission section 14 is formed into the inclined surface displacing forward as the press receiving surface 14a is closer to the tip end of the transmission section 14, the outer circumferential surface 7a is brought into a state of point contact or generally point contact with the press receiving surface 14a.

The rotation detection sensor 8 is coupled with, for example, a rear end portion of the rotary shaft 19 and has a function to detect a rotational angle and a rotation direction of the rotating element 6. Information regarding the rotational angle and the rotation direction of the rotating element 6 detected by the rotation detection sensor 8 is transmitted to a control circuit that exercises control to drive the optical elements such as the lens group, and the control circuit exercises control over movement or the like of the lens group in the optical axis direction.

It is noted that the rotation detection sensor 8 may detect a rotation amount and the rotation direction of the rotating element 6 in the interchangeable lens 1 in a state in which a rotation speed of the rotating element 6 is reduced by a speed reduction gear mechanism or the like.

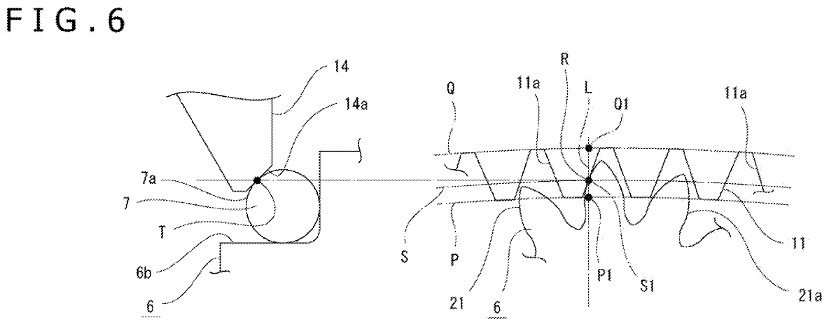

A contact position T at which the outer circumferential surface 7a of the transmission ring 7 contacts the press receiving surface 14a is located between an addendum circle P and a dedendum circle Q of the tooth section 11 at an engagement position R between the tooth section 11 and the gear section 21 in the radial direction of the operation ring 5, the rotating element 6, and the transmission ring 7 (refer to FIG. 6). Between the addendum circle P and the dedendum circle Q at the engagement position R indicates between a point P1 at which a line L connecting a rotation center of the operation ring 5 to the engagement position R intersects the addendum circle P and a point Q1 at which the L connecting a rotation center of the operation ring 5 to the engagement position R intersects the dedendum circle Q. It is particularly desirable that the contact position T at which the transmission ring 7 contacts the press receiving surface 14a coincides with a reference pitch circle S of the tooth section 11 at the engagement position R between the tooth section 11 and the gear section 21 in the radial direction of the operation ring 5, the rotating element 6, and the transmission ring 7. The reference pitch circle S of the tooth section 11 at the engagement position R refers to a point S1 at which the line L intersects the reference pitch circle S.

It is noted that there is a probability that the outer circumferential surface 7a of the transmission ring 7 is brought into a state of surface contact with the press receiving surface 14a of the transmission section 14. In this case, it is desirable that at least part of a contact surface of the outer circumferential surface 7a on which the outer circumferential surface 7a contacts the press receiving surface 14a is located between the addendum circle P and the dedendum circle Q of the tooth section 11 at the engagement position R between the tooth section 11 and the gear section 21 in the radial direction of the operation ring 5, the rotating element 6, and the transmission ring 7.

Furthermore, in this case, it is more desirable that a circumferential center of the contact surface of the outer circumferential surface 7a on which the outer circumferential surface 7a contacts the press receiving surface 14a is located between the addendum circle P and the dedendum circle Q of the tooth section 11 at the engagement position R between the tooth section 11 and the gear section 21 in the radial direction of the operation ring 5, the rotating element 6, and the transmission ring 7.

Moreover, it is desirable that in the state of the surface contact between the transmission ring 7 and the transmission section 14, at least part of the contact surface of the outer circumferential surface 7a on which the outer circumferential surface 7a contacts the press receiving surface 14a coincides with the reference pitch circle S of the tooth section 11 at the engagement position R between the tooth section 11 and the gear section 21 in the radial direction of the operation ring 5, the rotating element 6, and the transmission ring 7.

### <Operation Performed by Interchangeable Lens>

In the interchangeable lens 1 configured as described above, when the operation ring 5 is operated to be rotated, then the rotation power of the operation ring 5 is transmitted from the transmission section 14 to the rotating element 6 via the transmission ring 7, and the transmission ring 7 and the rotating element 6 are rotated integrally in the same direction as the rotation direction of the operation ring 5 in proportion to the rotation of the operation ring 5 with the rotary shaft 19 as the supporting point since the transmission ring 7 is pressed against the transmission section 14 of the operation ring 5.

Therefore, a backlash is not present in a rotation power transmission path differently from a structure in which the rotation power of the operation ring is transmitted to the rotating element via the gear mechanism, there is no failure of a delay in response since the operation ring is rotated but the rotating element is not rotated by as much as the backlash, and it is possible to ensure high responsiveness associated with rotation detection.

Furthermore, the rotation power of the operation ring 5 is transmitted to the rotating element 6 by the friction force between the transmission ring 7 and the operation ring 5; thus, it is possible to prevent generation of abnormal noise resulting from a collision between the gear racks and the gear teeth in the gear mechanism or the like due to the presence of the backlash.

Moreover, since the rotation power of the operation ring 5 is transmitted to the rotating element 6 by the friction force between the transmission ring 7 and the operation ring 5, it is possible to ensure favorable operational feeling at a time of operating the operation ring 5.

If moisture adheres to a contact part between the transmission section 14 of the operation ring 5 and the transmission ring 7 or the operation ring 5 is suddenly inverted due to an influence of a utilization environment in the interchangeable lens 1, the transmission ring 7 possibly slides relatively to the transmission section 14 at the time of rotating the operation ring 5. In this case, however, engagement between the tooth section 11 of the operation ring 5 and the gear section 21 of the rotating element 6 prevents larger slide than slide corresponding to the backlash. As a result, only a minimum amount of slide of the transmission ring 7 relative to the transmission section 14 is generated.

### <Conclusion>

As described above, in the interchangeable lens 1, the imaging apparatus 100, and the rotation detection apparatus 50, the transmission ring 7 is pressed against the operation ring 5, and the rotating element 6 is rotated by the rotation power transmitted from the operation ring 5 via the transmission ring 7.

Therefore, the rotating element 6 is rotated by the rotation power of the operation ring 5 transmitted via the transmission ring 7 by the friction force between the transmission ring 7 and the operation ring 5; thus it is possible to ensure a favorable transmission state of the rotation power from the operation ring 5 to the rotating element 6 and improve responsiveness associated with the rotation detection.

Furthermore, even in a case in which the transmission ring 7 slides relatively to the transmission section 14 at the time of rotating the operation ring 5, the amount of slide of the transmission ring 7 relative to the transmission section 14 is reduced by the engagement between the tooth section 11 of the operation ring 5 and the gear section 21 of the rotating element 6; thus, it is possible to restore the favorable transmission state of the rotation power from the operation ring 5 to the rotating element 6 early, and ensure high responsiveness associated with the rotation detection by ensuring the favorable transmission state of the rotation power from the operation ring 5 to the rotating element 6.

Moreover, the rotating element 6 is rotated coaxially and integrally with the transmission ring 7 by the rotation power of the operation ring 5 transmitted from the transmission section 14 to the rotating element 6 via the transmission ring 7.

Therefore, the rotation power is applied to the rotating element 6 from the operation ring 5 via the transmission ring 7 in a state in which the transmission ring 7 mounted to the rotating element 6 is pressed against the operation ring 5; thus, it is possible to ensure transmission of the rotation power of the operation ring 5 to the rotating element 6 by the friction force with a simple configuration.

Furthermore, the contact position T at which the transmission ring 7 contacts the transmission section 14 is located between the addendum circle P and the dedendum circle Q of the tooth section 11 at the engagement position between the tooth section 11 and the gear section 21.

Therefore, the transmission ring 7 and the rotating element 6 are brought into the state of contact with the transmission section 14 and the tooth section 11, respectively at the generally same position in the radial direction. Owing to this, it is difficult to apply a force that generates a speed difference between the transmission ring 7 and the rotating element 6 to the transmission ring 7 and the rotating element 6 when the rotation power is transmitted to the rotating element 6 from the operation ring 5, the slide of the transmission ring 7 relative to the rotating element 6 is suppressed and wear of the transmission ring 7 is suppressed, and it is possible to ensure a favorable integral rotation state of the transmission ring 7 and the rotating element 6.

In particular, since the contact position T of the transmission ring 7 at which the transmission ring 7 contacts the transmission section 14 coincides with the reference pitch circle S of the tooth section 11 at the engagement position between the tooth section 11 and the gear section 21, the transmission ring 7 and the rotating element 6 are brought into the state of contact with the transmission section 14 and the tooth section 11, respectively at the same position in the radial direction.

Therefore, the force that generates the speed difference between the transmission ring 7 and the rotating element 6 is not applied to the transmission ring 7 and the rotating element 6 when the rotation power is transmitted to the rotating element 6 from the operation ring 5, it is difficult to generate the slide of the transmission ring 7 relative to the rotating element 6 and it is difficult to generate the wear of the transmission ring 7, and it is possible to ensure a more favorable integral rotation state of the transmission ring 7 and the rotating element 6.

Moreover, in a case in which the transmission ring 7 and the transmission section 14 contact each other in the state of the surface contact, at least part of the contact surface is located between the addendum circle P and the dedendum circle Q of the tooth section 11 at the engagement position R between the tooth section 11 and the gear section 21; thus, the slide of the transmission ring 7 relative to the rotating element 6 is suppressed and the wear of the transmission ring 7 is suppressed, and it is possible to ensure the favorable integral rotation state of the transmission ring 7 and the rotating element 6.

In particular, since the circumferential center of the contact surface of the outer circumferential surface 7a on which the outer circumferential surface 7a contacts the press receiving surface 14a is located between the addendum circle P and the dedendum circle Q of the tooth section 11 at the engagement position R between the tooth section 11 and the gear section 21, it is possible to further suppress the slide of the transmission ring 7 relative to the rotating element 6, further suppress the wear of the transmission ring 7, and ensure a more favorable integral rotation state of the transmission ring 7 and the rotating element 6.

Furthermore, in the state in which the transmission ring 7 comes in surface contact with the transmission section 14, causing at least part of the contact surface of the outer circumferential surface 7a on which the outer circumferential surface 7a contacts the press receiving surface 14a to coincide with the reference pitch circle S of the tooth section 11 at the engagement position R between the tooth section 11 and the gear section 21 makes it possible to suppress the generation of the slide of the rotating element 6 relative to the transmission ring 7, to suppress the wear of the transmission ring 7, and to ensure the more favorable integral rotation state of the transmission ring 7 and the rotating element 6.

Moreover, the biasing spring 22 that biases the transmission ring 7 in the direction in which the outer circumferential portion of the transmission ring 7 is pressed against the transmission section 14 is provided.

Therefore, the outer circumferential portion of the transmission ring 7 is biased by the biasing spring 22 and pressed against the transmission section 14; thus, it is difficult to generate slide of the transmission ring 7 relative to the operation ring 5 at the time of rotating the operation ring 5, and it is possible to improve transmission efficiency for transmitting the rotation power of the operation ring 5 to the rotating element 6.

Moreover, the rotating element 6 and the transmission ring 7 are rotated with the rotary shaft 19 as the supporting point, and a biasing direction in which the biasing spring 22 biases the transmission ring 7 coincides with an axial direction of the rotary shaft 19.

Therefore, the transmission ring 7 is biased to the axial direction of the rotary shaft 19 by the biasing spring 22 and pressed against the transmission section 14; thus, the biasing force of the biasing spring 22 is not applied to the rotation direction of the rotating element 6 and the transmission ring 7, and it is possible to ensure a smooth rotation state of the rotating element 6 and the transmission ring 7.

Furthermore, the outer circumferential surface 7a of the transmission ring 7 pressed against the press receiving surface 14a of the transmission section 14 is formed into the curved shape projected outward.

Therefore, the outer circumferential surface 7a formed into the curved shape projected outward is pressed against the press receiving surface 14a; thus, it is easier to press the transmission ring 7 against the transmission section 14 in the state of the point contact, the transmission ring 7 and the rotating element 6 are smoothly rotated in proportion to the rotation of the operation ring 5, and it is possible to achieve an improvement in detection accuracy of the rotation detection sensor 8 associated with a rotation amount of the rotating element 6.

By forming the cross-sectional shape of the transmission ring 7 in the direction orthogonal to the circumferential direction into the circular shape, in particular, a shape of the transmission ring 7 is made simple; thus, it is possible to achieve improvements in the responsiveness and the detection accuracy associated with the rotation detection without entailing an increase in a manufacturing cost.

Moreover, the disposition recessed portion 6b is formed in the rotating element 6 to extend in the circumferential direction, and the transmission ring 7 is disposed in the disposition recessed portion 6b.

Therefore, the transmission ring 7 is pressed against the transmission section 14 in a state of being disposed in the disposition recessed portion 6b; thus, a combination of the rotating element 6 and the transmission ring 7 is not made large in size as a whole, and it is possible to achieve the improvements in the responsiveness and the detection accuracy associated with the rotation detection upon ensuring a size reduction.

Furthermore, since the tooth section 11 is provided on the inner circumferential side of the operation ring 5 and the gear section 21 provided as an external gear is engaged with the tooth section 11 provided as an internal gear, the rotating element 6 is in a state of being covered with the operation ring 5 from outside; thus, it is possible to suppress entry of dust into an interior of the operation ring 5 and ensure a favorable engaged state between the tooth section 11 and the gear section 21.

Additionally, since the transmission ring 7 is formed from the rubber material and the transmission ring 7 formed from the rubber material is pressed against the transmission section 14, the friction force between the transmission section 14 and the transmission ring 7 is high; thus, it is possible to prevent the slide of the transmission ring 7 relative to the transmission section 14 at the time of rotating the operation ring 5.

It is noted that the interchangeable lens 1 can be configured only by adding the transmission ring 7 and the biasing spring 22 as components, compared with a conventional interchangeable lens in which the rotation power of the operation ring is transmitted to the rotating element by the gear mechanism; thus, it is possible to ensure high responsiveness associated with the rotation detection by ensuring the favorable transmission state of the rotation power from the operation ring 5 to the rotating element 6 without making the size larger and entailing a considerable increase in the manufacturing cost.

### <Modifications of Interchangeable Lens>

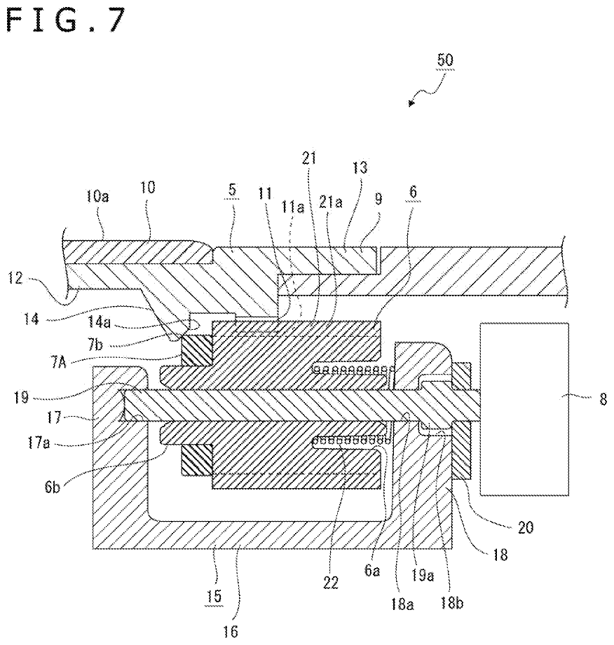

Modifications of the interchangeable lens 1 will next be described (refer to FIGS. 7 to 10). It is noted that description of sections that are not different from those in the interchangeable lens 1 described above will be omitted by adding similar reference signs to those added in the interchangeable lens 1 in the following modifications.

A first modification is a modification related to the shape of the transmission ring (refer to FIG. 7).

A cross-sectional shape of a transmission ring 7A according to the first modification in the direction orthogonal to the circumferential direction is formed into a non-circular shape, and this cross-sectional shape is formed into, for example, a rectangular shape. The biasing force of the biasing spring 22 is applied to the transmission ring 7A via the rotating element 6, and a corner portion 7b of the transmission ring 7A is brought into a state of contact with the press receiving surface 14a of the transmission section 14. It is noted that the cross-sectional shape of the transmission ring 7A in the direction orthogonal to the circumferential direction may be formed into a polygonal shape, an elliptical shape, or the like other than the circular shape or the rectangular shape as long as this cross-sectional shape is the non-circular shape.

Using the transmission ring 7A having the rectangular cross-sectional shape in the direction orthogonal to the circumferential direction makes it possible to bring each surface of the transmission ring 7A into a state of surface contact with each surface of the rotating element 6 in a state in which the transmission ring 7A is disposed in the disposition recessed portion 6b of the rotating element 6, and to ensure a rigid and stable mounted state of the transmission ring 7A to the rotating element 6.

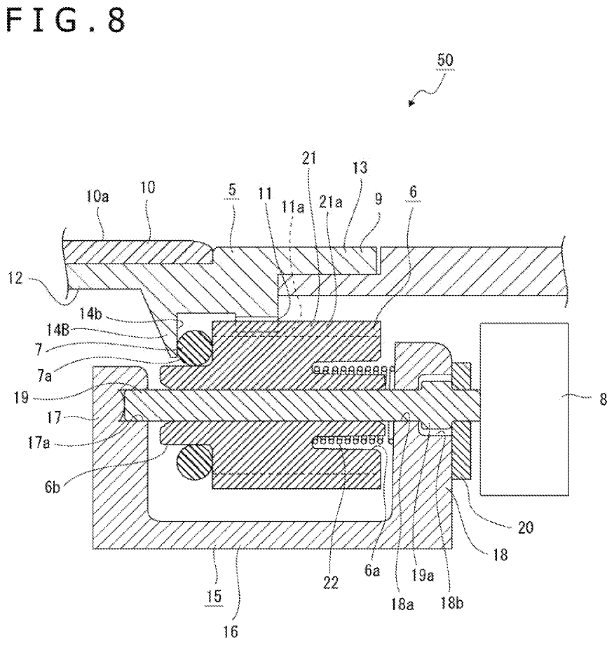

A second modification is a modification related to a direction in which the transmission ring is pressed against the operation ring (refer to FIG. 8).

A transmission section 14B according to the second modification is formed into a planar shape such that a press receiving surface 14b faces rearward. Therefore, the transmission ring 7 is pressed against the press receiving surface 14b facing rearward from straight behind.

By using the transmission section 14B having the press receiving surface 14b in this way, the transmission ring 7 is pressed against the press receiving surface 14b in a state of no force loss associated with the biasing force of the biasing spring 22; thus, it is possible to reduce the biasing force of the biasing spring 22 correspondingly and it is possible to reduce the manufacturing cost of the interchangeable lens 1 by a size reduction of the biasing spring 22.

It is noted that a configuration with the transmission section 14B having the press receiving surface 14b is also applicable to the transmission ring 7A having the non-circular cross-section according to the first modification.

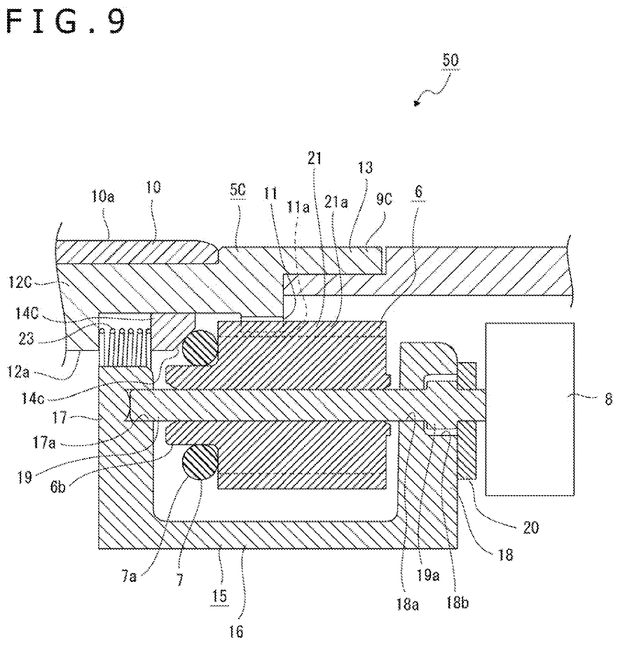

A third modification is a modification related to the biasing direction of the biasing spring (refer to FIG. 9).

An operation ring 5C according to the third modification is configured such that a front base section 12C and a transmission section 14C of a base ring 9C are formed from different members, and that the transmission section 14C is longitudinally movable relatively to the front base section 12C. A press receiving surface 14c formed as an inclined surface is formed on the transmission section 14C. A mounting protruding portion 12a is provided in the front base section 12C.

In the third modification, a biasing spring 23 biasing the transmission section 14C is used as an alternative to the biasing spring 22 biasing the rotating element 6. A compression coil spring, for example, is used as the biasing spring 23. A front end portion of the biasing spring 23 is mounted to the mounting protruding portion 12a, while a rear end portion thereof is mounted to a front surface of the transmission section 14C. Therefore, the transmission section 14C is biased rearward by the biasing spring 23 and the transmission ring 7 is pressed against the press receiving surface 14c.

Biasing the transmission section 14C in this way makes it possible to provide a configuration of pressing the transmission ring 7 against the transmission section 14C without disposing the biasing spring 23 on a holder 15 side or a rotating element 5 side, and to achieve an improvement in a degree of freedom of design.

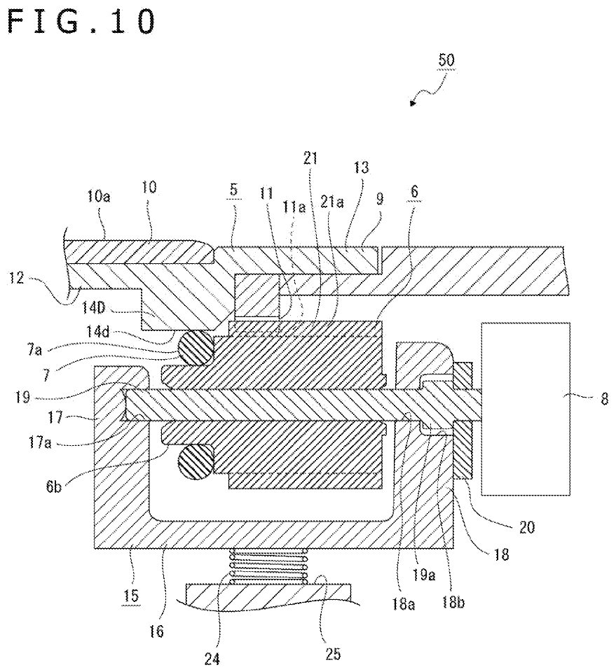

A fourth modification is similarly a modification related to the biasing direction of the biasing spring (refer to FIG. 10).

A transmission section 14D according to the fourth modification is formed into a shape such that a press receiving surface 14d faces inward in the radial direction of the operation ring 5. In the fourth modification, the holder 15 is configured vertically movable, and a biasing spring 24 disposed below the holder 15 is used as an alternative to the biasing spring 22 biasing the rotating element 6. A compression coil spring, for example, is used as the biasing spring 24.

A lower end portion of the biasing spring 24 is mounted to a spring mounting section 25 provided within the casing 2, and un upper end of the biasing spring 24 is pressed against a lower surface of the base 16 of the holder 15. Therefore, the holder 15, the rotary shaft 19, the rotating element 6, and the transmission ring 7 are biased upward by the biasing spring 24, and the transmission ring 7 is pressed against the press receiving surface 14d from below.

Biasing the holder 15 and the like in this way makes it possible to provide a configuration of disposing the biasing spring 24 outside of the holder 15 and pressing the transmission ring 7 against the transmission section 14D, to make effective use of a disposing space associated with the biasing spring 24, and to achieve the improvement in the degree of freedom of design.

### <Other Configuration of Interchangeable Lens>

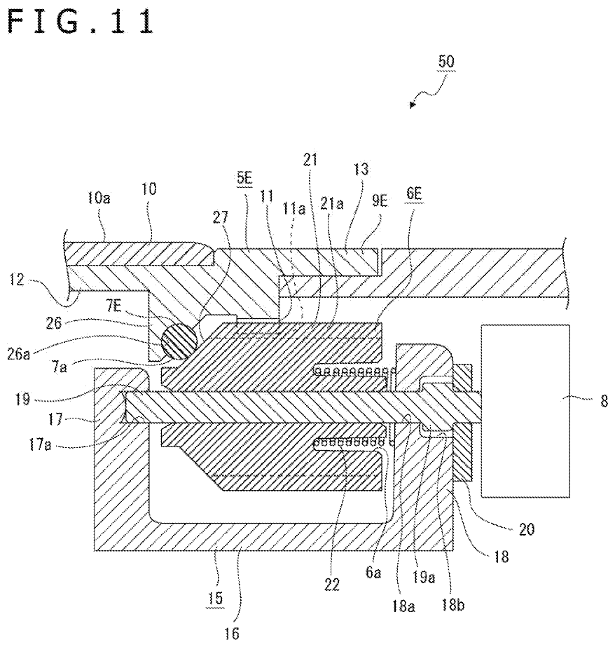

The other configuration of the interchangeable lens will be described hereinafter (refer to FIG. 11). It is noted that description of sections that are the same as those in the interchangeable lens 1 described above will be omitted by adding similar reference signs to those added in the interchangeable lens 1 in the other configuration described below, similarly to the modifications.

With this other configuration, an operation ring 5E having a base ring 9E that is not provided with the transmission section 14 is used, a ring mounting section 26 is provided in the operation ring 5E as an alternative to the transmission section 14, and a mounting recessed portion 26a is formed in the ring mounting section 26. A transmission ring 7E is mounted to the ring mounting section 26 in a state in which a portion of the transmission ring 7E is inserted into the mounting recessed portion 26a, and portions that are not inserted into the mounting recessed portion 26a protrude from the ring mounting section 26. Since the transmission ring 7E is mounted to the operation ring 5E, the transmission ring 7E is set larger in diameter than the transmission ring 7 mounted to the rotating element 6.

The disposition recessed portion 6b is not formed in a rotating element 6E, and a transmission receiving section 27 extending in the circumferential direction is formed in a front end portion of the rotating element 6E. The transmission receiving section 27 is formed into an inclined surface displacing toward the rotary shaft 19 side as being closer to the front.

The rotating element 6E is biased forward by the biasing spring 22, and the outer circumferential surface 7a of the transmission ring 7E is brought into a state of being pressed against the transmission receiving section 27 of the rotating element 6E from the front. Therefore, when the operation ring 5E is operated to be rotated, then the rotation power of the operation ring 5E is transmitted from the transmission ring 7E to the rotating element 6E via the transmission receiving section 27, and the rotating element 6E is rotated in the same direction as a rotation direction of the operation ring 5E in proportion to rotation of the operation ring 5E.

Since the cross-sectional shape of the transmission ring 7E in the direction orthogonal to the circumferential direction is formed into the circular shape and the transmission receiving section 27 is formed into the inclined surface displacing toward the rotary shaft 19 side as being closer to the front, the outer circumferential surface 7a is brought into a state of point contact or generally point contact with the transmission receiving section 27.

Information regarding a rotational angle and a rotation direction of the rotating element 6E detected by the rotation detection sensor 8 is transmitted to the control circuit that exercises control to drive the optical elements such as the lens group, and the control circuit exercises control over movement or the like of the lens group in the optical axis direction.

A contact position at which the outer circumferential surface 7a of the transmission ring 7E contacts the transmission receiving section 27 is located between the addendum circle and the dedendum circle of the tooth section 11 at the engagement position between the tooth section 11 and the gear section 21 in the radial direction of the operation ring 5E, the rotating element 6E, and the transmission ring 7E. It is particularly desirable that the contact position at which the transmission ring 7E contacts the transmission receiving section 27 coincides with the reference pitch circle of the tooth section 11 at the engagement position between the tooth section 11 and the gear section 21 in the radial direction of the operation ring 5E, the rotating element 6E, and the transmission ring 7E.

With such a configuration such that the transmission ring 7E is mounted to the operation ring 5E, the rotation power of the operation ring 5E is similarly transmitted to the rotating element 6E from the transmission ring 7E via the transmission receiving section 27 by a friction force. Therefore, a backlash is not present differently from the structure in which the rotation power of the operation ring is transmitted to the rotating element via the gear mechanism, there is no failure of a delay in response since the operation ring is rotated but the rotating element is not rotated by as much as the backlash, and it is possible to ensure high responsiveness associated with rotation detection.

Furthermore, the rotation power of the operation ring 5E is transmitted to the rotating element 6E by a friction force between the transmission ring 7E and the rotating element 6E; thus, it is possible to prevent generation of abnormal noise resulting from the collision between the gear racks and the gear teeth in the gear mechanism or the like due to the presence of the backlash.

Moreover, since the rotation power of the operation ring 5E is transmitted to the rotating element 6E by the friction force between the transmission ring 7E and the rotating element 6E, it is possible to ensure favorable operational feeling at a time of operating the operation ring 5E.

If moisture adheres to a contact part between the transmission receiving section 27 of the rotating element 6E and the transmission ring 7E or the operation ring 5E is suddenly inverted due to the influence of the utilization environment, the transmission receiving section 27 possibly slides relatively to the transmission ring 7E at the time of rotating the operation ring 5E. In this case, however, engagement between the tooth section 11 of the operation ring 5E and the gear section 21 of the rotating element 6E prevents larger slide than slide corresponding to the backlash. As a result, only a minimum amount of slide of the rotating element 6E relative to the transmission ring 7E is generated.

With the other configuration described above, the transmission ring 7E is pressed against the rotating element 6E, and the rotating element 6E is rotated by the rotation power transmitted to the rotating element 6E from the operation ring 5E via the transmission ring 7E.

Therefore, the rotating element 6E is rotated by the rotation power of the operation ring 5E transmitted via the transmission ring 7E by the friction force between the transmission ring 7E and the rotating element 6E; thus, it is possible to ensure a favorable transmission state of the rotation power from the operation ring 5E to the rotating element 6E and improve responsiveness associated with the rotation detection.

Furthermore, even in a case in which the transmission receiving section 27 slides relatively to the transmission ring 7 at the time of rotating the operation ring 5E, the amount of slide of the transmission receiving section 27 relative to the transmission ring 7E is reduced by the engagement between the tooth section 11 of the operation ring 5E and the gear section 21 of the rotating element 6E; thus, it is possible to restore the favorable transmission state of the rotation power from the operation ring 5E to the rotating element 6E early, and ensure high responsiveness associated with the rotation detection by ensuring the favorable transmission state of the rotation power from the operation ring 5E to the rotating element 6E.

Moreover, the rotating element 6E is rotated by the rotation power of the operation ring 5E transmitted from the transmission ring 7E via the transmission receiving section 27.

Therefore, the rotation power is applied to the rotating element 6E from the operation ring 5E via the transmission ring 7E in a state in which the transmission ring 7E mounted to the operation ring 5E is pressed against the rotating element 6E; thus, it is possible to ensure transmission of the rotation power of the operation ring 5E to the rotating element 6E by the friction force with a simple configuration.

Furthermore, the contact position at which the transmission ring 7E contacts the transmission receiving section 27 is located between the addendum circle and the dedendum circle of the tooth section 11 at the engagement position between the tooth section 11 and the gear section 21.

Therefore, the rotating element 6E is brought into the state of contact with the transmission ring 7E and the tooth section 11 at the generally same position in the radial direction. Owing to this, it is difficult to apply the force that generates the speed difference between the transmission ring 7E and the rotating element 6E to the transmission ring 7E and the rotating element 6E when the rotation power is transmitted to the rotating element 6E from the operation ring 5E, the slide of the rotating element 6E relative to the transmission ring 7E is suppressed and wear of the transmission ring 7E is suppressed, and it is possible to ensure the favorable rotation state of the rotating element 6E.

In particular, since the contact position of the transmission ring 7E at which the transmission ring 7E contacts the transmission receiving section 27 coincides with the reference pitch circle of the tooth section 11 at the engagement position between the tooth section 11 and the gear section 21, the rotating element 6E is brought into the state of contact with the transmission ring 7E and the tooth section 11 at the same position in the radial direction.

Therefore, the force that generates the speed difference between the transmission ring 7E and the rotating element 6E is not applied to the transmission ring 7E and the rotating element 6E when the rotation power is transmitted to the rotating element 6E from the operation ring 5E, it is difficult to generate the slide of the rotating element 6E relative to the transmission ring 7E and the wear of the transmission ring 7E is suppressed, and it is possible to ensure the more favorable rotation state of the rotating element 6E.

### <Others>

While the example in which the tooth section 11 provided as the internal gear is engaged with the gear section 21 provided as the external gear has been described above, the interchangeable lens can be configured conversely such that the tooth section provided as the external gear is engaged with the gear section 21 provided as the external gear.

Furthermore, the biasing member has been described while the biasing spring 22, 23, or 24 that is the compression coil spring is taken by way of example. Alternatively, a member of every kind such as a tension coil spring, a torsion coil spring, a plate spring formed from a metal material, a resin spring using elasticity of resin, a waved spring formed from a metal material, or a magnet may be used as the biasing member.

Furthermore, in the interchangeable lens 1, the control circuit may make setting to generate a so-called dead zone in which the rotation detection sensor 8 does not detect the rotation amount of the rotating element 6 or 6E at a certain rotational angle when the operation ring 5, 5C, or 5E is rotated. In this case, the control circuit may make setting to switch over a range of the dead zone depending on, for example, an operating state of each section.

### <One Embodiment of Imaging Apparatus>

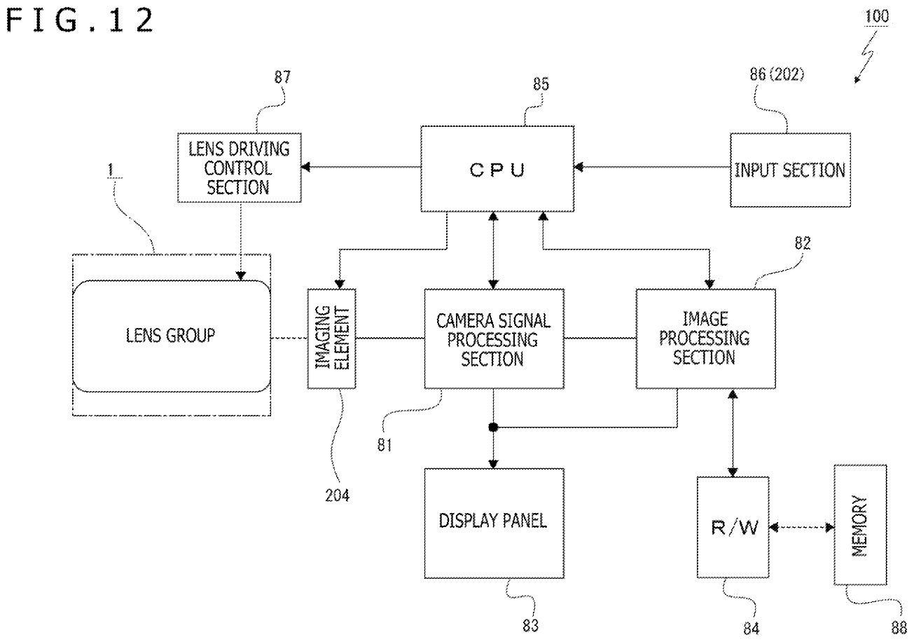

An example of a configuration of one embodiment of the imaging apparatus according to the present technology will be described hereinafter (refer to FIG. 12).

The imaging apparatus 100 has an image pickup element 204 that has a photoelectric conversion function to convert incorporated light into an electric signal, a camera signal processing section 81 that performs signal processes such as analog-to-digital conversion of a photographed image signal, and an image processing section 82 that performs recording/reproducing processes on the image signal. The imaging apparatus 100 is also configured with a display section 83 that displays a photographed image and the like, a reader-writer (R/W) 84 that writes and reads the image signal to and from a memory 88, a CPU (Central Processing Unit) 85 that exercises control over the entire imaging apparatus 100, an input section 86 (operation section 202) such as various kinds of switches with which the user performs required operations, and a lens driving control section 87 that controls the lens group (movable group) to be driven.

The camera signal processing section 81 performs various signal processes including conversion of an output signal from an image pickup element 204 into a digital signal, noise removal, image quality correction, and conversion into a luminance/color difference signal.

The image processing section 82 performs image signal compression and encoding/decompression and decoding processes based on a predetermined image data format, a conversion process on data specifications such as a resolution, and the like.

The display section 83 has a function to display various kinds of data about a user's operating state on the input section 86, the photographed image, and the like.

The R/W 84 writes image data encoded by the image processing section 82 to the memory 88 and reads image data recorded in the memory 88.

The CPU 85 functions as a control processing section that controls circuit blocks provided in the imaging apparatus 100, and controls each circuit block on the basis of an instruction input signal or the like from the input section 86.

The input section 86 outputs the instruction input signal in response to a user's operation to the CPU 85.

The lens driving control section 87 controls a motor and the like, which are not depicted, for driving the lens group on the basis of a control signal from the CPU 85.

The memory 88 is, for example, a semiconductor memory detachably attached to a slot connected to the R/W 84. It is noted that the memory 88 may be incorporated into the imaging apparatus 100 without being detachably attached to the slot.

Operations performed by the imaging apparatus 100 will be described hereinafter.

In a photographing waiting state, a photographed image signal is output to the display section 83 via the camera signal processing section 81 and displayed as a camera through image under control of the CPU 85. In addition, when the instruction input signal for zoom is input to the CPU 85 from the input section 86, then the CPU 85 outputs the control signal to the lens driving control section 87, and a predetermined lens group is moved on the basis of control of the lens driving control section 87.

When photographing is performed in response to the instruction input signal from the input section 86, then the photographed image signal is output from the camera signal processing section 81 to the image processing section 82, and the image processing section 82 performs the compression and encoding process on the image signal and converts the image signal into digital data in a predetermined data format. The data obtained by conversion is output to the R/W 84 and written to the memory 88.

The lens driving control section 87 moves the predetermined lens group on the basis of the control signal from the CPU 85, thereby performing focusing.

In a case of reproducing the image data recorded in the memory 88, then the R/W 84 reads predetermined image data from the memory 88 in response to an operation on the input section 86, the image processing section 82 performs the decompression and decoding process on the image data, a reproduced image signal is then output to the display section 83, and a reproduced image is displayed on the display section 83.

In the present technology, “imaging” refers to only part of or all of a series of processes from the photoelectric conversion process for converting the incorporated light into the electric signal by the image pickup element 204 to processes including the conversion of the output signal from the image pickup element 204 into the digital signal, the noise removal, the image quality correction, the conversion into the luminance/color difference signal, and the like by the camera signal processing section 81, the compression and encoding/decompression and decoding processes on the image signal based on the predetermined image data format and the conversion process on the data specifications such as the resolution by the image processing section 82, and the process for writing the image signal to the memory 88 by the R/W 84.

In other words, the “imaging” may only refer to the photoelectric conversion process for converting the incorporated light into the electric signal by the image pickup element 204, may refer to processes from the photoelectric conversion process for converting the incorporated light into the electric signal by the image pickup element 204 to the processes including the conversion of the output signal from the image pickup element 204 into the digital signal, the noise removal, the image quality correction, the conversion into the luminance/color difference signal, and the like by the camera signal processing section 81, may refer to processes from the photoelectric conversion process for converting the incorporated light into the electric signal by the image pickup element 204 to the compression and encoding/decompression and decoding processes on the image signal based on the predetermined image data format and the conversion process on the data specifications such as the resolution by the image processing section 82 through the processes including the conversion of the output signal from the image pickup element 204 into the digital signal, the noise removal, the image quality correction, the conversion into the luminance/color difference signal, and the like by the camera signal processing section 81, may refer to processes from the photoelectric conversion process for converting the incorporated light into the electric signal by the image pickup element 204 to the processes including the conversion of the output signal from the image pickup element 204 into the digital signal, the noise removal, the image quality correction, the conversion into the luminance/color difference signal, and the like by the camera signal processing section 81, the compression and encoding/decompression and decoding processes on the image signal based on the predetermined image data format and the conversion process on the data specifications such as the resolution by the image processing section 82, and may refer to processes up to the process for wiring the image signal to the memory 88 by the R/W 84. In the processes, an order of the processes may be changed as appropriate.

Furthermore, in the present technology, the interchangeable lens 1 and a photographing apparatus 100 may be configured with only some of or all of the image pickup element 204, the camera signal processing section 81, the image processing section 82, and the R/W 84 performing the above processes.

Moreover, the interchangeable lens 1 may be configured with some of the image pickup element 204, the camera signal processing section 81, the image processing section 82, and the R/W 84, and the apparatus main body 200 may be configured with a remainder thereof.

### <Present Technology>

The present technology can be configured as follows.

(1) An interchangeable lens including:

an operation ring that has a tooth section extending in a rotation direction and that is operated to be rotatable;

a rotating element that has a gear section provided in an outer circumferential portion and engaged with the tooth section, a rotation amount of the rotating element being detected by a rotation detection sensor; and

a transmission ring that is rotated in proportion to rotation of the operation ring, and that transmits rotation power of the operation ring to the rotating element, in which

the transmission ring is pressed against either the operation ring or the rotating element, and

the rotating element is rotated by the rotation power transmitted from the operation ring via the transmission ring.

(2) The interchangeable lens according to (1), in which

a transmission section is provided in the operation ring,

the transmission ring is mounted to the rotating element and an outer circumferential portion of the transmission ring is pressed against the transmission section, and

the rotating element is rotated coaxially and integrally with the transmission ring by the rotation power of the operation ring transmitted from the transmission section via the transmission ring.

(3) The interchangeable lens according to (2), in which

at least part of a contact surface of the transmission ring on which the transmission ring contacts the transmission section is located between an addendum circle and a dedendum circle of the tooth section at an engagement position between the tooth section and the gear section in a radial direction of the rotating element.

(4) The interchangeable lens according to (3), in which

a circumferential center of the contact surface is located between the addendum circle and the dedendum circle of the tooth section at the engagement position between the tooth section and the gear section in the radial direction of the rotating element.

(5) The interchangeable lens according to (2), in which

at least part of a contact surface of the transmission ring on which the transmission ring contacts the transmission section coincides with a reference pitch circle of the tooth section at an engagement position between the tooth section and the gear section in a radial direction of the rotating element.

(6) The interchangeable lens according to (2), in which

a contact position of the transmission ring at which the transmission ring contacts the transmission section is located between an addendum circle and a dedendum circle of the tooth section at an engagement position between the tooth section and the gear section in a radial direction of the rotating element.

(7) The interchangeable lens according to (6), in which

the contact position of the transmission ring at which the transmission ring contacts the transmission section coincides with a reference pitch circle of the tooth section at the engagement position between the tooth section and the gear section in the radial direction of the rotating element.

(8) The interchangeable lens according to any one of (2) to (7), in which

a biasing member that biases the transmission ring in a direction in which the outer circumferential portion of the transmission ring is pressed against the transmission section is provided.

(9) The interchangeable lens according to (8), in which

the rotating element and the transmission ring are rotated with a rotary shaft used as a supporting point, and

a biasing direction in which the biasing member biases the transmission ring is made to coincide with an axial direction of the rotary shaft.

(10) The interchangeable lens according to any one of (2) to (9), in which

a press receiving surface against which the transmission ring is pressed is formed on the transmission section, and

an outer circumferential surface of the transmission ring is formed into a curved shape projected outward.

(11) The interchangeable lens according to (10), in which

a cross-sectional shape of the transmission ring in a direction orthogonal to a circumferential direction is formed into a circular shape.

(12) The interchangeable lens according to any one of (1) to (11), in which

a disposition recessed portion extending in a circumferential direction is formed in the rotating element, and the transmission ring is disposed in the disposition recessed portion.

(13) The interchangeable lens according to any one of (1) to (12), in which

the tooth section is provided on an inner circumferential side of the operation ring.

(14) The interchangeable lens according to any one of (1) to (13), in which

the transmission ring is formed from a rubber material.

(15) The interchangeable lens according to (1), in which

a transmission receiving section is provided on the rotating element,

the transmission ring is mounted to the operation ring and the outer circumferential portion of the transmission ring is pressed against the transmission receiving section, and

the rotating element is rotated by the rotation power of the operation ring transmitted via the transmission receiving section.

(16) The interchangeable lens according to (13), in which

a contact position of the transmission ring at which the transmission ring contacts the transmission receiving section is located between an addendum circle and a dedendum circle of the tooth section at an engagement position between the tooth section and the gear section in a radial direction of the rotating element.

(17) The interchangeable lens according to (16), in which

the contact position of the transmission ring at which the transmission ring contacts the transmission receiving section is made to coincide with a reference pitch circle of the tooth section at the engagement position between the tooth section and the gear section in the radial direction of the rotating element.

(18) An imaging apparatus including:

an interchangeable lens that has a lens disposed therein; and

an image pickup element that converts an optical image incorporated via the interchangeable lens into an electrical signal, in which

the interchangeable lens includes
an operation ring that has a tooth section extending in a rotation direction and that is operated to be rotatable,
a rotating element that has a gear section provided in an outer circumferential portion and engaged with the tooth section,
a rotation detection sensor that detects a rotation amount of the rotating element, and
a transmission ring that is rotated in proportion to rotation of the operation ring, and that transmits rotation power of the operation ring to the rotating element,

the transmission ring is pressed against either the operation ring or the rotating element, and

the rotating element is rotated by the rotation power transmitted from the operation ring via the transmission ring.

(19) A rotation detection apparatus including:

an operation ring that has a tooth section extending in a rotation direction and that is operated to be rotatable;

a rotating element that has a gear section provided in an outer circumferential portion and engaged with the tooth section;

a rotation detection sensor that detects a rotation amount of the rotating element; and

a transmission ring that is rotated in proportion to rotation of the operation ring, and that transmits rotation power of the operation ring to the rotating element, in which

the transmission ring is pressed against either the operation ring or the rotating element, and

the rotating element is rotated by the rotation power transmitted from the operation ring via the transmission ring.

### Application Example

The technology according to the present disclosure can be applied to various products. For example, the technology according to the present disclosure may be applied to an operation section of an endoscopic surgery system and the like.

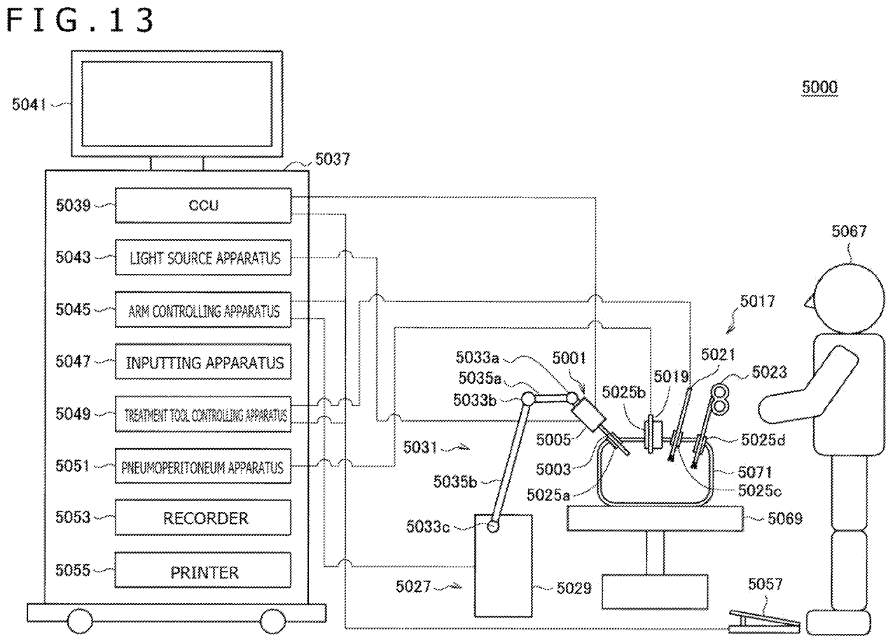

FIG. 13 is a view depicting an example of a schematic configuration of an endoscopic surgery system 5000 to which the technology according to an embodiment of the present disclosure can be applied. In FIG. 13, a state is illustrated in which a surgeon (medical doctor) 5067 is using the endoscopic surgery system 5000 to perform surgery for a patient 5071 on a patient bed 5069. As depicted, the endoscopic surgery system 5000 includes an endoscope 5001, other surgical tools 5017, a supporting arm apparatus 5027 which supports the endoscope 5001 thereon, and a cart 5037 on which various apparatus for endoscopic surgery are mounted.

In endoscopic surgery, in place of incision of the abdominal wall to perform laparotomy, a plurality of tubular aperture devices called trocars 5025a to 5025d are used to puncture the abdominal wall. Then, a lens barrel 5003 of the endoscope 5001 and the other surgical tools 5017 are inserted into body cavity of the patient 5071 through the trocars 5025a to 5025d. In the example depicted, as the other surgical tools 5017, a pneumoperitoneum tube 5019, an energy device 5021 and forceps 5023 are inserted into body cavity of the patient 5071. Further, the energy device 5021 is a treatment tool for performing incision and peeling of a tissue, sealing of a blood vessel or the like by high frequency current or ultrasonic vibration. However, the surgical tools 5017 depicted are mere examples at all, and as the surgical tools 5017, various surgical tools which are generally used in endoscopic surgery such as, for example, tweezers or a retractor may be used.

An image of a surgical region in a body cavity of the patient 5071 imaged by the endoscope 5001 is displayed on a display apparatus 5041. The surgeon 5067 would use the energy device 5021 or the forceps 5023 while watching the image of the surgical region displayed on the display apparatus 5041 on the real time basis to perform such treatment as, for example, resection of an affected area. It is to be noted that, though not depicted, the pneumoperitoneum tube 5019, the energy device 5021 and the forceps 5023 are supported by the surgeon 5067, an assistant or the like during surgery.

### (Supporting Arm Apparatus)

The supporting arm apparatus 5027 includes an arm unit 5031 extending from a base unit 5029. In the example depicted, the arm unit 5031 includes joint portions 5033a, 5033b and 5033c and links 5035a and 5035b and is driven under the control of an arm controlling apparatus 5045. The endoscope 5001 is supported by the arm unit 5031 such that the position and the posture of the endoscope 5001 are controlled. Consequently, stable fixation in position of the endoscope 5001 can be implemented.

### (Endoscope)

The endoscope 5001 includes the lens barrel 5003 which has a region of a predetermined length from a distal end thereof to be inserted into a body cavity of the patient 5071, and a camera head 5005 connected to a proximal end of the lens barrel 5003. In the example depicted, the endoscope 5001 is depicted as a rigid endoscope having the lens barrel 5003 of the hard type. However, the endoscope 5001 may otherwise be configured as a flexible endoscope having the lens barrel 5003 of the flexible type.

The lens barrel 5003 has, at a distal end thereof, an opening in which an objective lens is fitted. A light source apparatus 5043 is connected to the endoscope 5001 such that light generated by the light source apparatus 5043 is introduced to a distal end of the lens barrel by a light guide extending in the inside of the lens barrel 5003 and is irradiated toward an observation target in a body cavity of the patient 5071 through the objective lens. It is to be noted that the endoscope 5001 may be a forward-viewing endoscope or may be an oblique-viewing endoscope or a side-viewing endoscope.

An optical system and an image pickup element are provided in the inside of the camera head 5005 such that reflected light (observation light) from an observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 5039. It is to be noted that the camera head 5005 has a function incorporated therein for suitably driving the optical system of the camera head 5005 to adjust the magnification and the focal distance.

It is to be noted that, in order to establish compatibility with, for example, a stereoscopic vision (three dimensional (3D) display), a plurality of image pickup elements may be provided on the camera head 5005. In this case, a plurality of relay optical systems are provided in the inside of the lens barrel 5003 in order to guide observation light to each of the plurality of image pickup elements.

### (Various Apparatus Incorporated in Cart)

The CCU 5039 includes a central processing unit (CPU), a graphics processing unit (GPU) or the like and integrally controls operation of the endoscope 5001 and the display apparatus 5041. In particular, the CCU 5039 performs, for an image signal received from the camera head 5005, various image processes for displaying an image based on the image signal such as, for example, a development process (demosaic process). The CCU 5039 provides the image signal for which the image processes have been performed to the display apparatus 5041. Further, the CCU 5039 transmits a control signal to the camera head 5005 to control driving of the camera head 5005. The control signal may include information relating to an image pickup condition such as a magnification or a focal distance.

The display apparatus 5041 displays an image based on an image signal for which the image processes have been performed by the CCU 5039 under the control of the CCU 5039. If the endoscope 5001 is ready for imaging of a high resolution such as 4K (horizontal pixel number 3840×vertical pixel number 2160), 8K (horizontal pixel number 7680×vertical pixel number 4320) or the like and/or ready for 3D display, then a display apparatus by which corresponding display of the high resolution and/or 3D display are possible may be used as the display apparatus 5041. Where the apparatus is ready for imaging of a high resolution such as 4K or 8K, if the display apparatus used as the display apparatus 5041 has a size of equal to or not less than 55 inches, then a more immersive experience can be obtained. Further, a plurality of display apparatus 5041 having different resolutions and/or different sizes may be provided in accordance with purposes.

The light source apparatus 5043 includes a light source such as, for example, a light emitting diode (LED) and supplies irradiation light for imaging of a surgical region to the endoscope 5001.

The arm controlling apparatus 5045 includes a processor such as, for example, a CPU and operates in accordance with a predetermined program to control driving of the arm unit 5031 of the supporting arm apparatus 5027 in accordance with a predetermined controlling method.

An inputting apparatus 5047 is an input interface for the endoscopic surgery system 5000. A user can perform inputting of various kinds of information or instruction inputting to the endoscopic surgery system 5000 through the inputting apparatus 5047. For example, the user would input various kinds of information relating to surgery such as physical information of a patient, information regarding a surgical procedure of the surgery and so forth through the inputting apparatus 5047. Further, the user would input, for example, an instruction to drive the arm unit 5031, an instruction to change an image pickup condition (type of irradiation light, magnification, focal distance or the like) by the endoscope 5001, an instruction to drive the energy device 5021 or the like through the inputting apparatus 5047.

The type of the inputting apparatus 5047 is not limited and may be that of any one of various known inputting apparatus. As the inputting apparatus 5047, for example, a mouse, a keyboard, a touch panel, a switch, a foot switch 5057 and/or a lever or the like may be applied. Where a touch panel is used as the inputting apparatus 5047, it may be provided on the display face of the display apparatus 5041.

Otherwise, the inputting apparatus 5047 is a device to be mounted on a user such as, for example, a glasses type wearable device or a head mounted display (HMD), and various kinds of inputting are performed in response to a gesture or a line of sight of the user detected by any of the devices mentioned. Further, the inputting apparatus 5047 includes a camera which can detect a motion of a user, and various kinds of inputting are performed in response to a gesture or a line of sight of a user detected from a video imaged by the camera. Further, the inputting apparatus 5047 includes a microphone which can collect the voice of a user, and various kinds of inputting are performed by voice collected by the microphone. By configuring the inputting apparatus 5047 such that various kinds of information can be inputted in a contactless fashion in this manner, especially a user who belongs to a clean area (for example, the surgeon 5067) can operate an apparatus belonging to an unclean area in a contactless fashion. Further, since the user can operate an apparatus without releasing a possessed surgical tool from its hand, the convenience to the user is improved.

A treatment tool controlling apparatus 5049 controls driving of the energy device 5021 for cautery or incision of a tissue, sealing of a blood vessel or the like. A pneumoperitoneum apparatus 5051 feeds gas into a body cavity of the patient 5071 through the pneumoperitoneum tube 5019 to inflate the body cavity in order to secure the field of view of the endoscope 5001 and secure the working space for the surgeon. A recorder 5053 is an apparatus capable of recording various kinds of information relating to surgery. A printer 5055 is an apparatus capable of printing various kinds of information relating to surgery in various forms such as a text, an image or a graph.

In the following, especially a characteristic configuration of the endoscopic surgery system 5000 is described in more detail.

### (Supporting Arm Apparatus)

The supporting arm apparatus 5027 includes the base unit 5029 serving as a base, and the arm unit 5031 extending from the base unit 5029. In the example depicted, the arm unit 5031 includes the plurality of joint portions 5033a, 5033b and 5033c and the plurality of links 5035a and 5035b connected to each other by the joint portion 5033b. In FIG. 13, for simplified illustration, the configuration of the arm unit 5031 is depicted in a simplified form. Actually, the shape, number and arrangement of the joint portions 5033a to 5033c and the links 5035a and 5035b and the direction and so forth of axes of rotation of the joint portions 5033a to 5033c can be set suitably such that the arm unit 5031 has a desired degree of freedom. For example, the arm unit 5031 may preferably be configured such that it has a degree of freedom equal to or not less than 6 degrees of freedom. This makes it possible to move the endoscope 5001 freely within the movable range of the arm unit 5031. Consequently, it becomes possible to insert the lens barrel 5003 of the endoscope 5001 from a desired direction into a body cavity of the patient 5071.

An actuator is provided in each of the joint portions 5033a to 5033c, and the joint portions 5033a to 5033c are configured such that they are rotatable around predetermined axes of rotation thereof by driving of the respective actuators. The driving of the actuators is controlled by the arm controlling apparatus 5045 to control the rotational angle of each of the joint portions 5033a to 5033c thereby to control driving of the arm unit 5031. Consequently, control of the position and the posture of the endoscope 5001 can be implemented. Thereupon, the arm controlling apparatus 5045 can control driving of the arm unit 5031 by various known controlling methods such as force control or position control.

For example, if the surgeon 5067 suitably performs operation inputting through the inputting apparatus 5047 (including the foot switch 5057), then driving of the arm unit 5031 may be controlled suitably by the arm controlling apparatus 5045 in response to the operation input to control the position and the posture of the endoscope 5001. After the endoscope 5001 at the distal end of the arm unit 5031 is moved from an arbitrary position to a different arbitrary position by the control just described, the endoscope 5001 can be supported fixedly at the position after the movement. It is to be noted that the arm unit 5031 may be operated in a master-slave fashion. In this case, the arm unit 5031 may be remotely controlled by the user through the inputting apparatus 5047 which is placed at a place remote from the operating room.

Further, where force control is applied, the arm controlling apparatus 5045 may perform power-assisted control to drive the actuators of the joint portions 5033a to 5033c such that the arm unit 5031 may receive external force by the user and move smoothly following the external force. This makes it possible to move, when the user directly touches with and moves the arm unit 5031, the arm unit 5031 with comparatively weak force. Accordingly, it becomes possible for the user to move the endoscope 5001 more intuitively by a simpler and easier operation, and the convenience to the user can be improved.

Here, generally in endoscopic surgery, the endoscope 5001 is supported by a medical doctor called scopist. In contrast, where the supporting arm apparatus 5027 is used, the position of the endoscope 5001 can be fixed more certainly without hands, and therefore, an image of a surgical region can be obtained stably and surgery can be performed smoothly.

It is to be noted that the arm controlling apparatus 5045 may not necessarily be provided on the cart 5037. Further, the arm controlling apparatus 5045 may not necessarily be a single apparatus. For example, the arm controlling apparatus 5045 may be provided in each of the joint portions 5033a to 5033c of the arm unit 5031 of the supporting arm apparatus 5027 such that the plurality of arm controlling apparatus 5045 cooperate with each other to implement driving control of the arm unit 5031.

### (Light Source Apparatus)

The light source apparatus 5043 supplies irradiation light upon imaging of a surgical region to the endoscope 5001. The light source apparatus 5043 includes a white light source which includes, for example, an LED, a laser light source or a combination of them. In this case, where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 5043. Further, in this case, if laser beams from the respective RGB laser light sources are irradiated time-divisionally on an observation target and driving of the image pickup elements of the camera head 5005 is controlled in synchronism with the irradiation timings, then images individually corresponding to the R, G and B colors can be picked up time-divisionally. According to the method just described, a color image can be obtained even if a color filter is not provided for the image pickup element.

Further, driving of the light source apparatus 5043 may be controlled such that the intensity of light to be outputted is changed for each predetermined time. By controlling driving of the image pickup element of the camera head 5005 in synchronism with the timing of the change of the intensity of light to acquire images time-divisionally and synthesizing the images, an image of a high dynamic range free from underexposed blocked up shadows and overexposed highlights can be created.

Further, the light source apparatus 5043 may be configured to supply light of a predetermined wavelength band ready for special light observation. In special light observation, for example, by utilizing the wavelength dependency of absorption of light in a body tissue to irradiate light of a narrower wavelength band in comparison with irradiation light upon ordinary observation (namely, white light), narrow band light observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 5043 can be configured to supply such narrow-band light and/or excitation light suitable for special light observation as described above.

### (Camera Head and CCU)

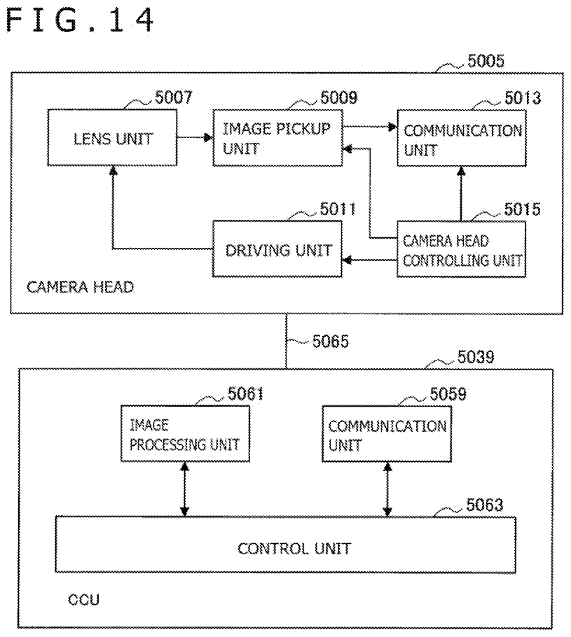

Functions of the camera head 5005 of the endoscope 5001 and the CCU 5039 are described in more detail with reference to FIG. 14. FIG. 14 is a block diagram depicting an example of a functional configuration of the camera head 5005 and the CCU 5039 depicted in FIG. 13.

Referring to FIG. 14, the camera head 5005 has, as functions thereof, a lens unit 5007, an image pickup unit 5009, a driving unit 5011, a communication unit 5013 and a camera head controlling unit 5015. Further, the CCU 5039 has, as functions thereof, a communication unit 5059, an image processing unit 5061 and a control unit 5063. The camera head 5005 and the CCU 5039 are connected to be bidirectionally communicable to each other by a transmission cable 5065.

First, a functional configuration of the camera head 5005 is described. The lens unit 5007 is an optical system provided at a connecting location of the camera head 5005 to the lens barrel 5003. Observation light taken in from a distal end of the lens barrel 5003 is introduced into the camera head 5005 and enters the lens unit 5007. The lens unit 5007 includes a combination of a plurality of lenses including a zoom lens and a focusing lens. The lens unit 5007 has optical properties adjusted such that the observation light is condensed on a light receiving face of the image pickup element of the image pickup unit 5009. Further, the zoom lens and the focusing lens are configured such that the positions thereof on their optical axis are movable for adjustment of the magnification and the focal point of a picked up image.

The image pickup unit 5009 includes an image pickup element and disposed at a succeeding stage to the lens unit 5007. Observation light having passed through the lens unit 5007 is condensed on the light receiving face of the image pickup element, and an image signal corresponding to the observation image is generated by photoelectric conversion of the image pickup element. The image signal generated by the image pickup unit 5009 is provided to the communication unit 5013.

As the image pickup element which is included by the image pickup unit 5009, an image sensor, for example, of the complementary metal oxide semiconductor (CMOS) type is used which has a Bayer array and is capable of picking up an image in color. It is to be noted that, as the image pickup element, an image pickup element may be used which is ready, for example, for imaging of an image of a high resolution equal to or not less than 4K. If an image of a surgical region is obtained in a high resolution, then the surgeon 5067 can comprehend a state of the surgical region in enhanced details and can proceed with the surgery more smoothly.

Further, the image pickup element which is included by the image pickup unit 5009 includes such that it has a pair of image pickup elements for acquiring image signals for the right eye and the left eye compatible with 3D display. Where 3D display is applied, the surgeon 5067 can comprehend the depth of a living body tissue in the surgical region more accurately. It is to be noted that, if the image pickup unit 5009 is configured as that of the multi-plate type, then a plurality of systems of lens units 5007 are provided corresponding to the individual image pickup elements of the image pickup unit 5009.

The image pickup unit 5009 may not necessarily be provided on the camera head 5005. For example, the image pickup unit 5009 may be provided just behind the objective lens in the inside of the lens barrel 5003.

The driving unit 5011 includes an actuator and moves the zoom lens and the focusing lens of the lens unit 5007 by a predetermined distance along the optical axis under the control of the camera head controlling unit 5015. Consequently, the magnification and the focal point of a picked up image by the image pickup unit 5009 can be adjusted suitably.

The communication unit 5013 includes a communication apparatus for transmitting and receiving various kinds of information to and from the CCU 5039. The communication unit 5013 transmits an image signal acquired from the image pickup unit 5009 as RAW data to the CCU 5039 through the transmission cable 5065. Thereupon, in order to display a picked up image of a surgical region in low latency, preferably the image signal is transmitted by optical communication. This is because, upon surgery, the surgeon 5067 performs surgery while observing the state of an affected area through a picked up image, it is demanded for a moving image of the surgical region to be displayed on the real time basis as far as possible in order to achieve surgery with a higher degree of safety and certainty. Where optical communication is applied, a photoelectric conversion module for converting an electric signal into an optical signal is provided in the communication unit 5013. After the image signal is converted into an optical signal by the photoelectric conversion module, it is transmitted to the CCU 5039 through the transmission cable 5065.

Further, the communication unit 5013 receives a control signal for controlling driving of the camera head 5005 from the CCU 5039. The control signal includes information relating to image pickup conditions such as, for example, information that a frame rate of a picked up image is designated, information that an exposure value upon image picking up is designated and/or information that a magnification and a focal point of a picked up image are designated. The communication unit 5013 provides the received control signal to the camera head controlling unit 5015. It is to be noted that also the control signal from the CCU 5039 may be transmitted by optical communication. In this case, a photoelectric conversion module for converting an optical signal into an electric signal is provided in the communication unit 5013. After the control signal is converted into an electric signal by the photoelectric conversion module, it is provided to the camera head controlling unit 5015.

It is to be noted that the image pickup conditions such as the frame rate, exposure value, magnification or focal point are set automatically by the control unit 5063 of the CCU 5039 on the basis of an acquired image signal. In other words, an auto exposure (AE) function, an auto focus (AF) function and an auto white balance (AWB) function are incorporated in the endoscope 5001.

The camera head controlling unit 5015 controls driving of the camera head 5005 on the basis of a control signal from the CCU 5039 received through the communication unit 5013. For example, the camera head controlling unit 5015 controls driving of the image pickup element of the image pickup unit 5009 on the basis of information that a frame rate of a picked up image is designated and/or information that an exposure value upon image picking up is designated. Further, for example, the camera head controlling unit 5015 controls the driving unit 5011 to suitably move the zoom lens and the focus lens of the lens unit 5007 on the basis of information that a magnification and a focal point of a picked up image are designated. The camera head controlling unit 5015 may further include a function for storing information for identifying the lens barrel 5003 and/or the camera head 5005.

It is to be noted that, by disposing the components such as the lens unit 5007 and the image pickup unit 5009 in a sealed structure having high airtightness and waterproof, the camera head 5005 can be provided with resistance to an autoclave sterilization process.

Now, a functional configuration of the CCU 5039 is described. The communication unit 5059 includes a communication apparatus for transmitting and receiving various kinds of information to and from the camera head 5005. The communication unit 5059 receives an image signal transmitted thereto from the camera head 5005 through the transmission cable 5065. Thereupon, the image signal may be transmitted preferably by optical communication as described above. In this case, for the compatibility with optical communication, the communication unit 5059 includes a photoelectric conversion module for converting an optical signal into an electric signal. The communication unit 5059 provides the image signal after conversion into an electric signal to the image processing unit 5061.

Further, the communication unit 5059 transmits, to the camera head 5005, a control signal for controlling driving of the camera head 5005. The control signal may also be transmitted by optical communication.

The image processing unit 5061 performs various image processes for an image signal in the form of RAW data transmitted thereto from the camera head 5005. The image processes include various known signal processes such as, for example, a development process, an image quality improving process (a bandwidth enhancement process, a super-resolution process, a noise reduction (NR) process and/or an image stabilization process) and/or an enlargement process (electronic zooming process). Further, the image processing unit 5061 performs a detection process for an image signal in order to perform AE, AF and AWB.

The image processing unit 5061 includes a processor such as a CPU or a GPU, and when the processor operates in accordance with a predetermined program, the image processes and the detection process described above can be performed. It is to be noted that, where the image processing unit 5061 includes a plurality of GPUs, the image processing unit 5061 suitably divides information relating to an image signal such that image processes are performed in parallel by the plurality of GPUs.

The control unit 5063 performs various kinds of control relating to image picking up of a surgical region by the endoscope 5001 and display of the picked up image. For example, the control unit 5063 generates a control signal for controlling driving of the camera head 5005. Thereupon, if image pickup conditions are inputted by the user, then the control unit 5063 generates a control signal on the basis of the input by the user. Alternatively, where the endoscope 5001 has an AE function, an AF function and an AWB function incorporated therein, the control unit 5063 suitably calculates an optimum exposure value, focal distance and white balance in response to a result of a detection process by the image processing unit 5061 and generates a control signal.

Further, the control unit 5063 controls the display apparatus 5041 to display an image of a surgical region on the basis of an image signal for which image processes have been performed by the image processing unit 5061. Thereupon, the control unit 5063 recognizes various objects in the surgical region image using various image recognition technologies. For example, the control unit 5063 can recognize a surgical tool such as forceps, a particular living body region, bleeding, mist when the energy device 5021 is used and so forth by detecting the shape, color and so forth of edges of the objects included in the surgical region image. The control unit 5063 causes, when it controls the display unit 5041 to display a surgical region image, various kinds of surgery supporting information to be displayed in an overlapping manner with an image of the surgical region using a result of the recognition. Where surgery supporting information is displayed in an overlapping manner and presented to the surgeon 5067, the surgeon 5067 can proceed with the surgery more safety and certainty.

The transmission cable 5065 which connects the camera head 5005 and the CCU 5039 to each other is an electric signal cable ready for communication of an electric signal, an optical fiber ready for optical communication or a composite cable ready for both of electrical and optical communication.

Here, while, in the example depicted, communication is performed by wired communication using the transmission cable 5065, the communication between the camera head 5005 and the CCU 5039 may be performed otherwise by wireless communication. Where the communication between the camera head 5005 and the CCU 5039 is performed by wireless communication, there is no necessity to lay the transmission cable 5065 in the operating room. Therefore, such a situation that movement of medical staff in the operating room is disturbed by the transmission cable 5065 can be eliminated.

An example of the endoscopic surgery system 5000 to which the technology according to an embodiment of the present disclosure can be applied has been described above. It is to be noted here that, although the endoscopic surgery system 5000 has been described as an example, the system to which the technology according to an embodiment of the present disclosure can be applied is not limited to the example. For example, the technology according to an embodiment of the present disclosure may be applied to a flexible endoscopic system for inspection or a microscopic surgery system.

The technology according to the present disclosure is suitably applicable to an operation section of the endoscope among the configurations described so far. Specifically, by operating the operation ring 5, the endoscope can be moved. Applying the technology according to the present disclosure to the operation section of the endoscope makes it possible to achieve an improvement in accuracy for a movement position of the endoscope.

### REFERENCE SIGNS LIST

100 . . . Imaging apparatus, 1 . . . Interchangeable lens, 5 . . . Operation ring, 6 . . . Rotating element, 7 . . . Transmission ring, 7a . . . Outer circumferential surface, 8 . . . Rotation detection sensor, 11 . . . Tooth section, 14 . . . Transmission section, 14a . . . Press receiving surface, 19 . . . Rotary shaft, 21 . . . Gear section, 22 . . . Biasing member (biasing spring), 50 . . . Rotation detection apparatus, 7a . . . Transmission ring, 14B . . . Transmission section, 14b . . . Press receiving surface, 5C . . . Operation ring, 14C . . . Transmission section, 23 . . . Biasing member (biasing spring), 14D . . . Transmission section, 14d . . . Press receiving surface, 24 . . . Biasing member (biasing spring), 5E . . . Operation ring, 6E . . . Rotating element, 7E . . . Transmission ring, 27 . . . Transmission receiving section

1. An interchangeable lens comprising:
an operation ring that has a tooth section extending in a rotation direction and that is operated to be rotatable;
a rotating element that has a gear section provided in an outer circumferential portion and engaged with the tooth section, a rotation amount of the rotating element being detected by a rotation detection sensor; and
a transmission ring that is rotated in proportion to rotation of the operation ring, and that transmits rotation power of the operation ring to the rotating element, wherein
the transmission ring is pressed against either the operation ring or the rotating element, and
the rotating element is rotated by the rotation power transmitted from the operation ring via the transmission ring.

2. The interchangeable lens according to claim 1, wherein
a transmission section is provided in the operation ring,
the transmission ring is mounted to the rotating element and an outer circumferential portion of the transmission ring is pressed against the transmission section, and
the rotating element is rotated coaxially and integrally with the transmission ring by the rotation power of the operation ring transmitted from the transmission section via the transmission ring.

3. The interchangeable lens according to claim 2, wherein
at least part of a contact surface of the transmission ring on which the transmission ring contacts the transmission section is located between an addendum circle and a dedendum circle of the tooth section at an engagement position between the tooth section and the gear section in a radial direction of the rotating element.

4. The interchangeable lens according to claim 3, wherein
a circumferential center of the contact surface is located between the addendum circle and the dedendum circle of the tooth section at the engagement position between the tooth section and the gear section in the radial direction of the rotating element.

5. The interchangeable lens according to claim 2, wherein
at least part of a contact surface of the transmission ring on which the transmission ring contacts the transmission section coincides with a reference pitch circle of the tooth section at an engagement position between the tooth section and the gear section in a radial direction of the rotating element.

6. The interchangeable lens according to claim 2, wherein
a contact position of the transmission ring at which the transmission ring contacts the transmission section is located between an addendum circle and a dedendum circle of the tooth section at an engagement position between the tooth section and the gear section in a radial direction of the rotating element.

7. The interchangeable lens according to claim 6, wherein
the contact position of the transmission ring at which the transmission ring contacts the transmission section coincides with a reference pitch circle of the tooth section at the engagement position between the tooth section and the gear section in the radial direction of the rotating element.

8. The interchangeable lens according to claim 2, wherein
a biasing member that biases the transmission ring in a direction in which the outer circumferential portion of the transmission ring is pressed against the transmission section is provided.

9. The interchangeable lens according to claim 8, wherein
the rotating element and the transmission ring are rotated with a rotary shaft used as a supporting point, and
a biasing direction in which the biasing member biases the transmission ring is made to coincide with an axial direction of the rotary shaft.

10. The interchangeable lens according to claim 2, wherein
a press receiving surface against which the transmission ring is pressed is formed on the transmission section, and
an outer circumferential surface of the transmission ring is formed into a curved shape projected outward.

11. The interchangeable lens according to claim 10, wherein
a cross-sectional shape of the transmission ring in a direction orthogonal to a circumferential direction is formed into a circular shape.

12. The interchangeable lens according to claim 1, wherein
a disposition recessed portion extending in a circumferential direction is formed in the rotating element, and
the transmission ring is disposed in the disposition recessed portion.

13. The interchangeable lens according to claim 1, wherein
the tooth section is provided on an inner circumferential side of the operation ring.

14. The interchangeable lens according to claim 1, wherein
the transmission ring is formed from a rubber material.

15. The interchangeable lens according to claim 1, wherein
a transmission receiving section is provided on the rotating element,
the transmission ring is mounted to the operation ring and the outer circumferential portion of the transmission ring is pressed against the transmission receiving section, and
the rotating element is rotated by the rotation power of the operation ring transmitted via the transmission receiving section.

16. The interchangeable lens according to claim 15, wherein
at least part of a contact surface of the transmission ring on which the transmission ring contacts the transmission receiving section is located between an addendum circle and a dedendum circle of the tooth section at an engagement position between the tooth section and the gear section in a radial direction of the rotating element.

17. The interchangeable lens according to claim 16, wherein
a contact position of the transmission ring at which the transmission ring contacts the transmission receiving section is made to coincide with a reference pitch circle of the tooth section at the engagement position between the tooth section and the gear section in the radial direction of the rotating element.

18. An imaging apparatus comprising:
an interchangeable lens that has a lens disposed therein; and
an image pickup element that converts an optical image incorporated via the interchangeable lens into an electrical signal, wherein
the interchangeable lens includes
an operation ring that has a tooth section extending in a rotation direction and that is operated to be rotatable,
a rotating element that has a gear section provided in an outer circumferential portion and engaged with the tooth section,
a rotation detection sensor that detects a rotation amount of the rotating element, and
a transmission ring that is rotated in proportion to rotation of the operation ring, and that transmits rotation power of the operation ring to the rotating element,
the transmission ring is pressed against either the operation ring or the rotating element, and
the rotating element is rotated by the rotation power transmitted from the operation ring via the transmission ring.

19. A rotation detection apparatus comprising:
an operation ring that has a tooth section extending in a rotation direction and that is operated to be rotatable;
a rotating element that has a gear section provided in an outer circumferential portion and engaged with the tooth section;
a rotation detection sensor that detects a rotation amount of the rotating element; and
a transmission ring that is rotated in proportion to rotation of the operation ring, and that transmits rotation power of the operation ring to the rotating element, wherein
the transmission ring is pressed against either the operation ring or the rotating element, and
the rotating element is rotated by the rotation power transmitted from the operation ring via the transmission ring.
